(19) United States
(12) Patent Application Publication
(10) Pub. No.: US 2018/0075767 A1
(43) Pub. Date: Mar. 15, 2018

(54) SKILLS ASSESSMENT SYSTEMS AND METHODS

(71) Applicant: Kea Skills, LLC, Chicago, IL (US)

(72) Inventor: Patricia Gorman, Wilton, CT (US)

(21) Appl. No.: 15/438,327

(22) Filed: Feb. 21, 2017

Related U.S. Application Data
(60) Provisional application No. 62/298,215, filed on Feb. 22, 2016.

(51) Int. Cl. G09B 7/02; G06Q 10/10; G09B 19/00

(52) U.S. Cl. CPC G09B 7/02; G09B 19/0053; G09B 19/00; G06Q 10/1053

(57) ABSTRACT

Systems and methods are provided for providing skills assessment of a participant. A database is used by at least one algorithm to select a set of challenges and distractions that make up an assessment experience for the participant to interact with via one or more electronic devices. An online interface provides front end access by the participant to the system. A tracking and evaluation module monitors and evaluates the participant's decisions during the assessment. A scoring module aggregates the participant's decisions into a composite score reflecting a level and type of business acumen and a reporting module generates reports based on the assessment.

### CROSS-REFERENCE TO RELATED APPLICATIONS

This application claims the benefit of U.S. patent application Ser. No. 62/298,215, filed on Feb. 22, 2016, which is incorporated in its entirety herein by reference.

### BACKGROUND

The present disclosure generally relates to skills assessment, and more particularly to skills assessment systems and methods.

### SUMMARY

According to some aspects, the subject technology relates to a system for providing skills assessment. The system includes one or more processors and a computer-readable medium having instructions for determining one or more challenges for a participant, providing the one or more challenges to at least one electronic device associated with the participant, monitoring responses of the participant to the one or more challenges, wherein the responses are input via the at least one electronic device, and determining a performance assessment for the participant based on the responses of the participant to the one or more challenges.

According to some aspects, the subject technology relates to a computer implemented method for providing skills assessment. The method includes determining, by one or more processors, one or more challenges for a participant and providing the one or more challenges to at least one electronic device associated with the participant. The method also includes monitoring, by the one or more processors, responses of the participant to the one or more challenges, wherein the responses are input via the at least one electronic device and providing, by the one or more processors, one or more distractions to the at least one electronic device. The method further includes monitoring, by the one or more processors, responses of the participant to the one or more distractions, wherein the responses are input via the at least one electronic device and determining, by the one or more processors, a performance assessment for the participant based on the responses of the participant to the one or more challenges and the one or more distractions.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an exemplar skills assessment analysis that may be implemented in accordance with one or more embodiments of the skills assessment system.

FIGS. 2-1 and 2-2 illustrate a summary of an example process for a skills assessment system in accordance with one or more embodiments.

FIGS. 3-1 through 11G-2 illustrate flow diagrams of example processes for a skills assessment system in accordance with one or more embodiments.

FIG. 12 conceptually illustrates an electronic system with which one or more embodiments of the subject technology may be implemented.

FIG. 13 illustrates an example network environment in which a skills assessment system may be implemented in accordance with one or more embodiments.

### DETAILED DESCRIPTION

In the following detailed description, numerous specific details are set forth to provide a full understanding of the present disclosure. It will be apparent, however, to one ordinarily skilled in the art that embodiments of the present disclosure may be practiced without some of the specific details. In other instances, well-known structures and techniques have not been shown in detail so as not to obscure the disclosure. In the referenced drawings, like numbered elements are the same or essentially similar. Reference numbers may have letter suffixes appended to indicate separate instances of a common element while being referred to generically by the same number without a suffix letter.

Hiring entities (e.g., companies, government agencies) may have a variety of ways to assess the skills or talents of current employees or prospective job candidates. Similarly, individuals have a variety of methods in which to objectively provide detailed information of their qualifications and capabilities. However, assessments made based on resumes, letters of recommendation and background checks give an incomplete and potentially erroneous assessment of the skills and talents of a particular person, much less the likelihood of that person succeeding in a particular job or position. Accordingly, it is desired to provide methods and systems for providing any of assessment of employees, evaluation of job candidates, selection of candidates for leadership roles, selection of candidates for strategic projects and initiatives, relative ranking of candidates for promotions and advancement and the ability for ‘under-qualified’ candidates to demonstrate competence and thereby overcome biases associated with lack of academic degrees and political power.

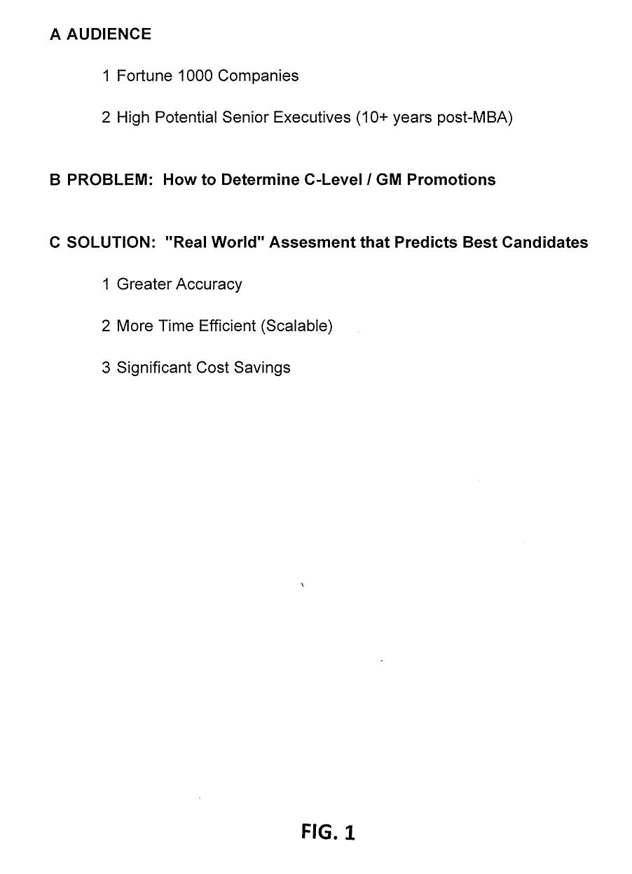

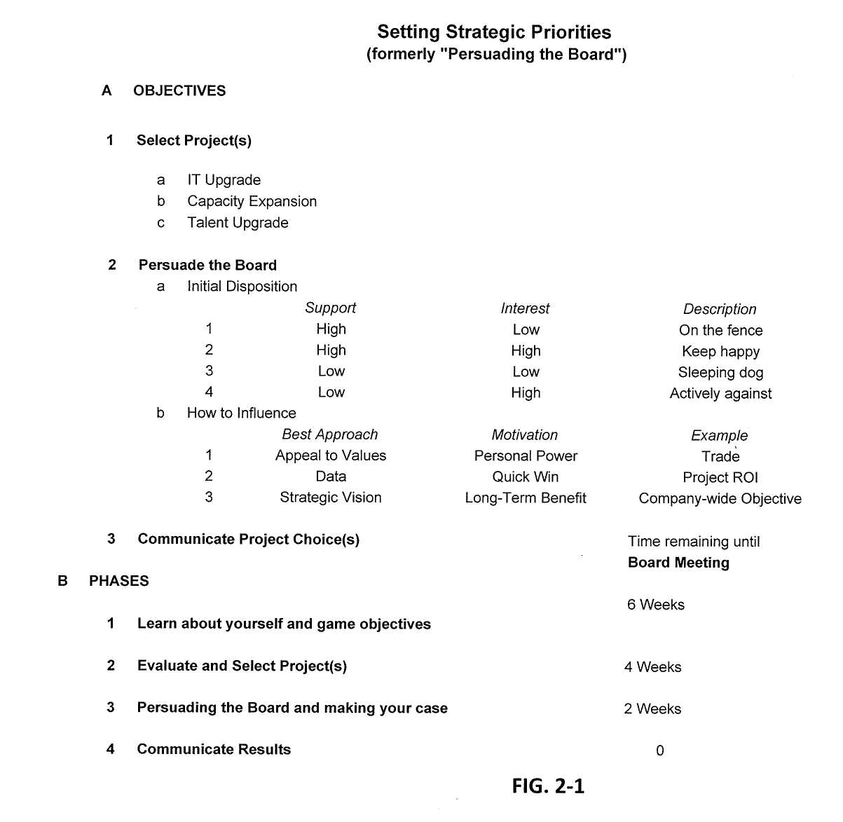

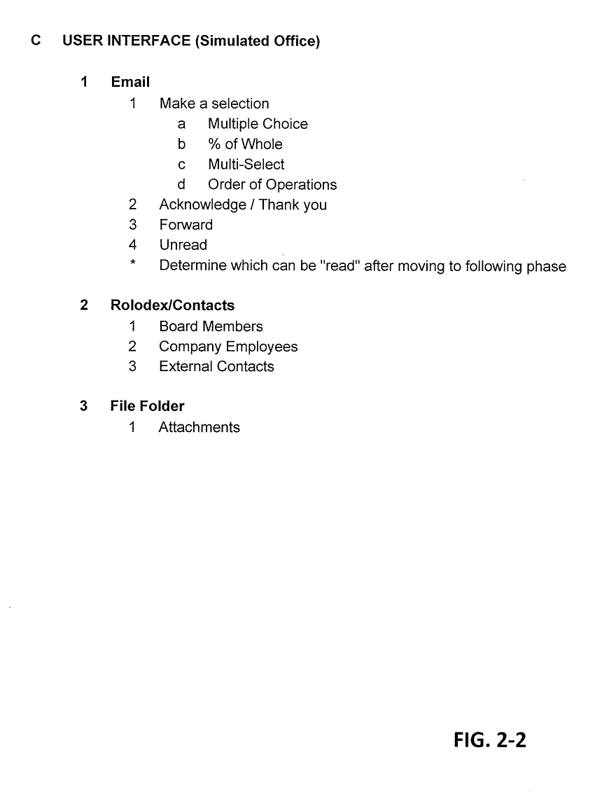

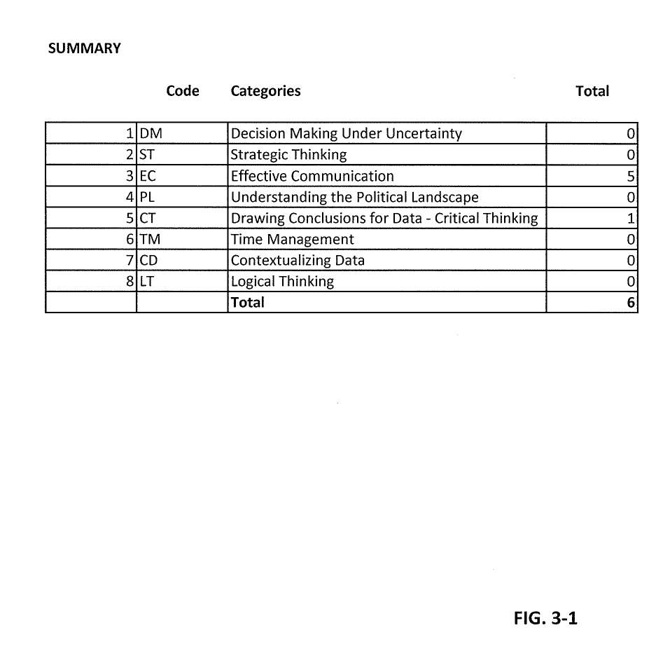

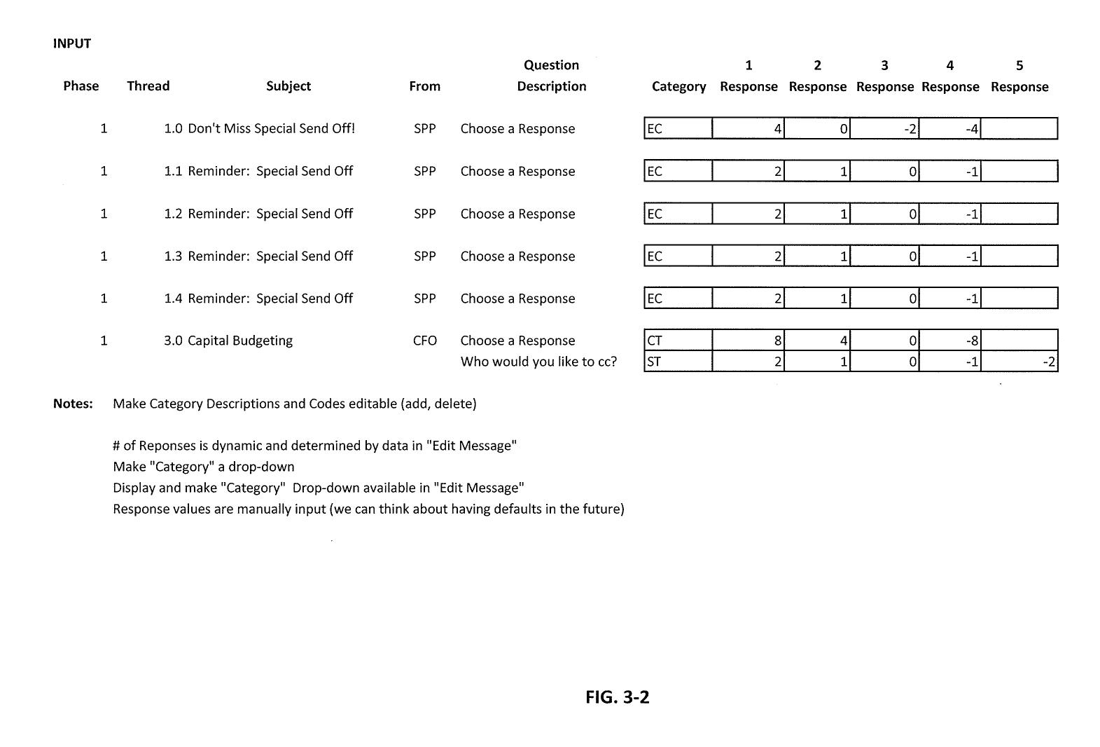

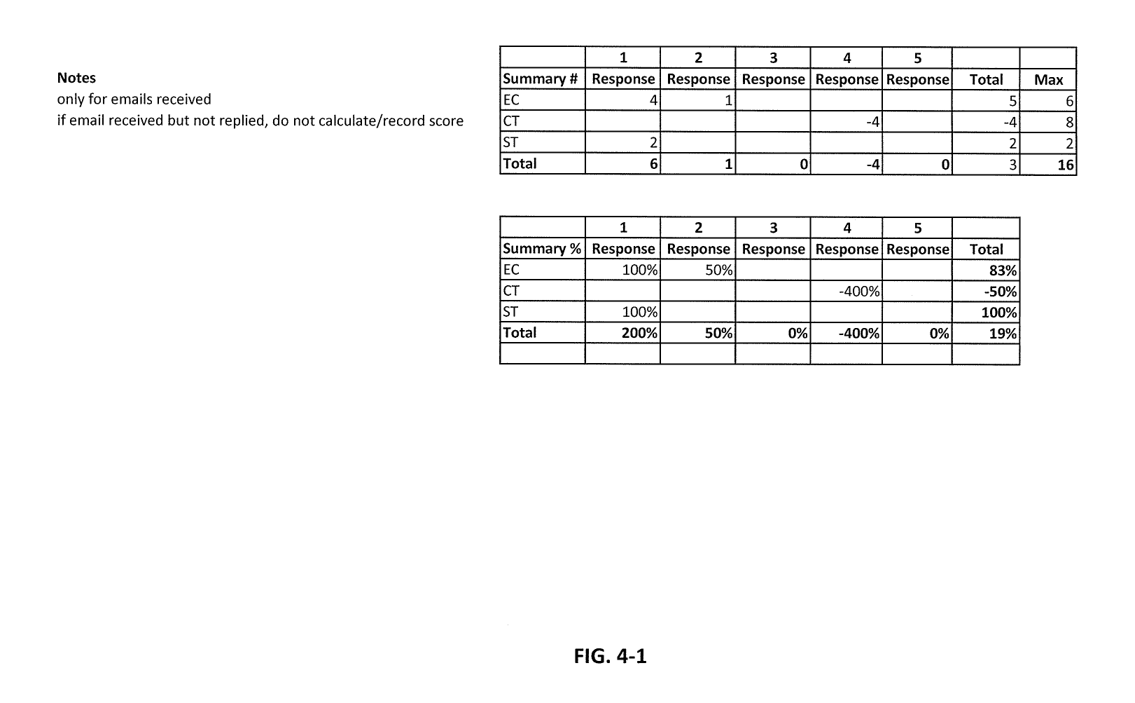

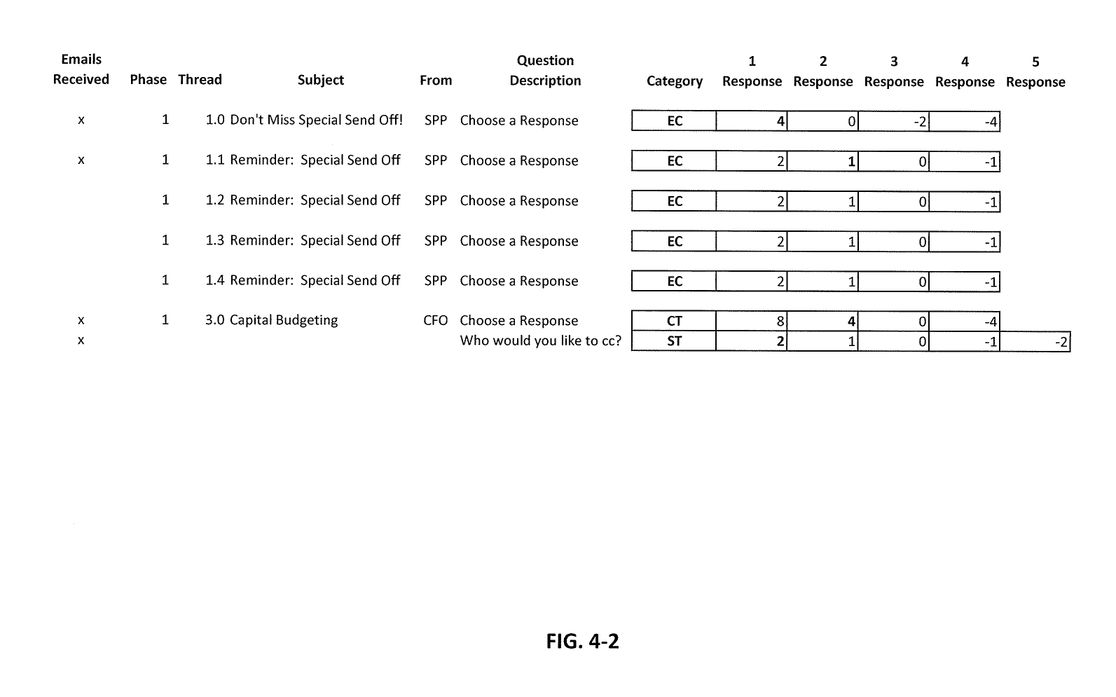

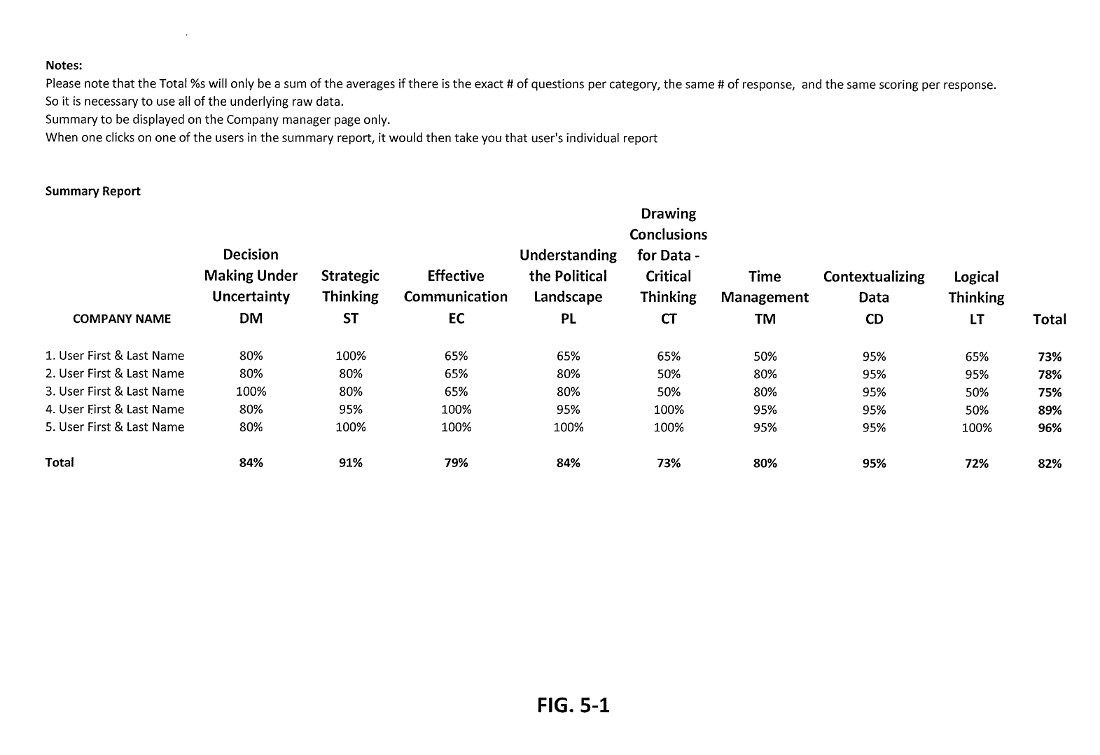

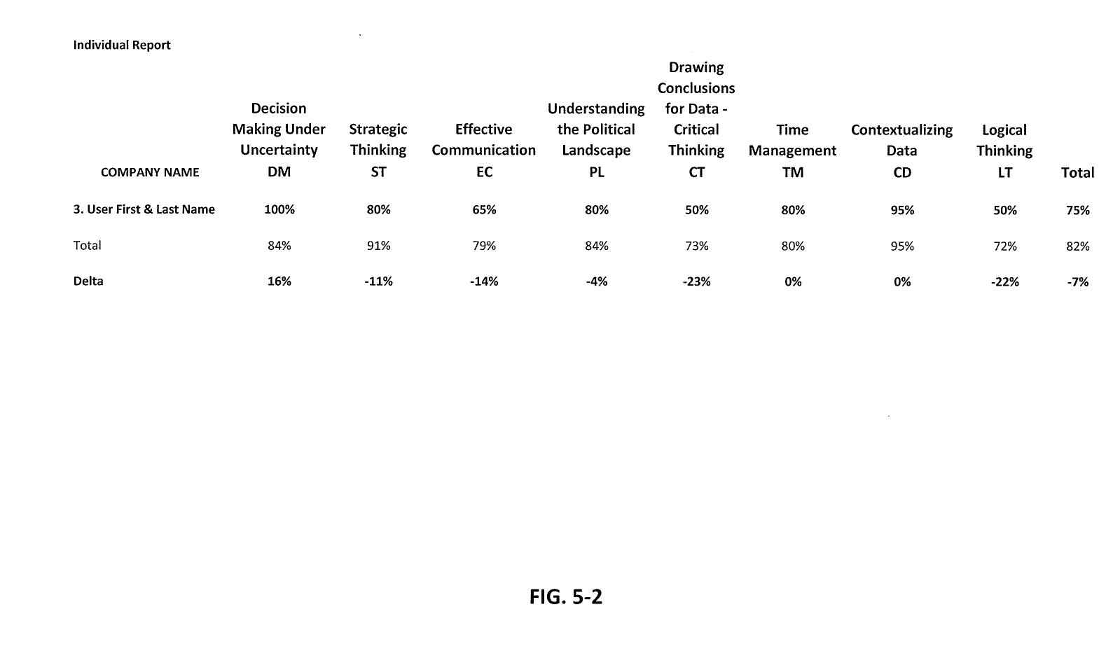

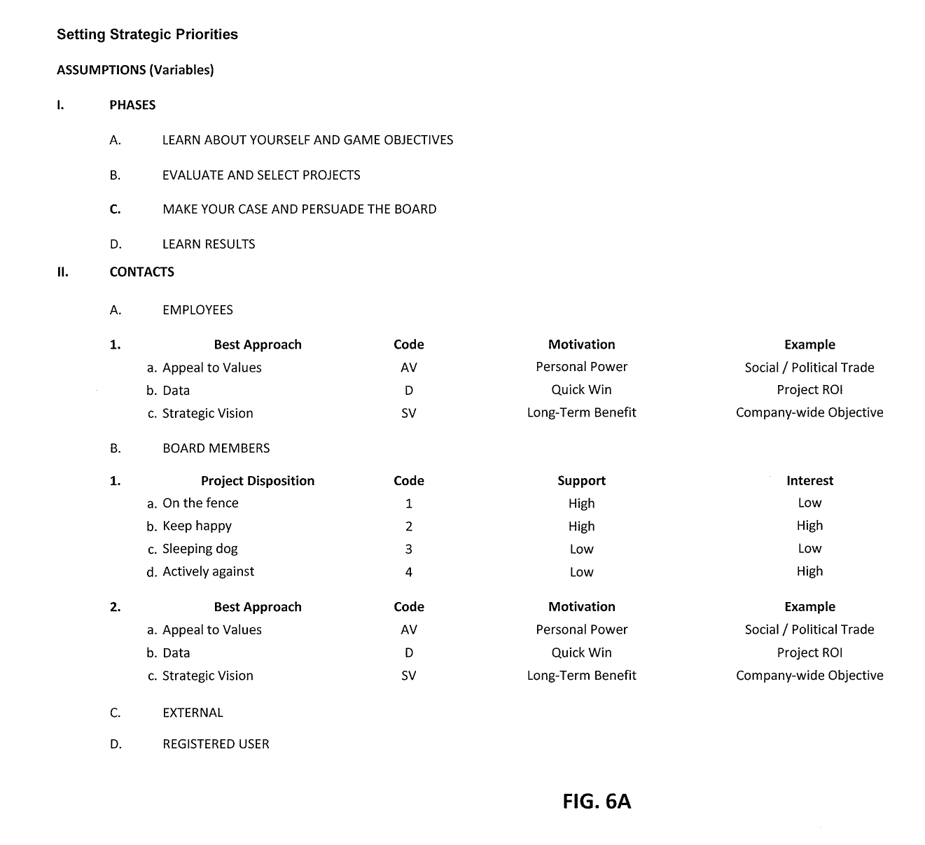

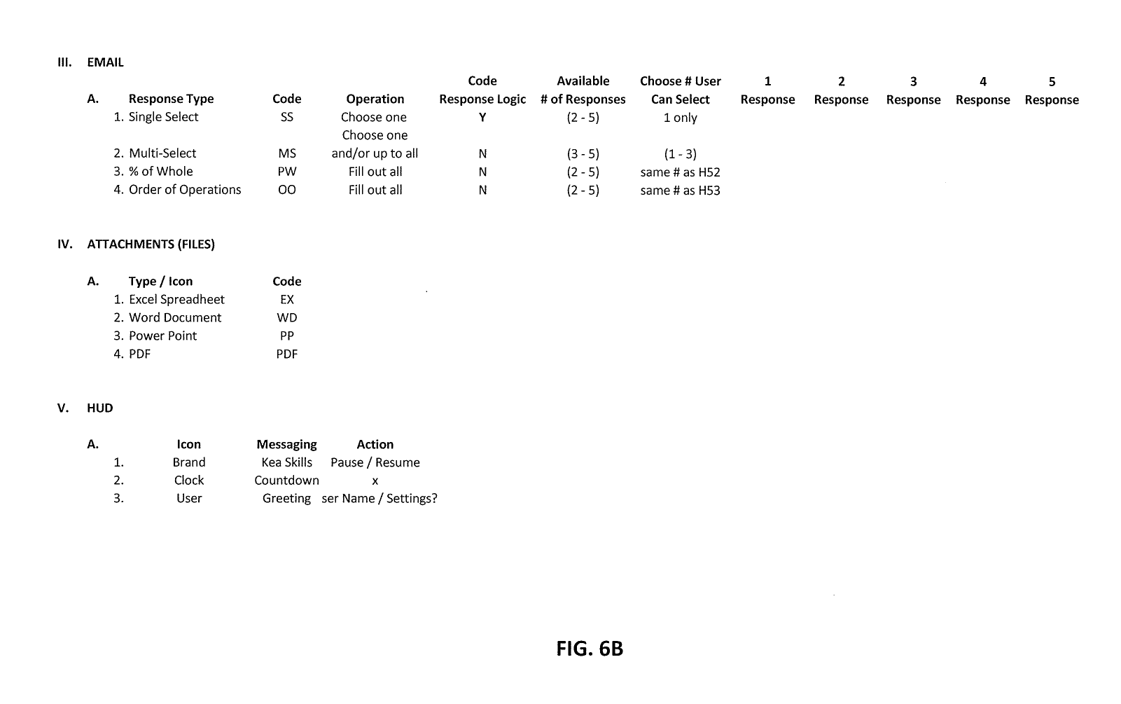

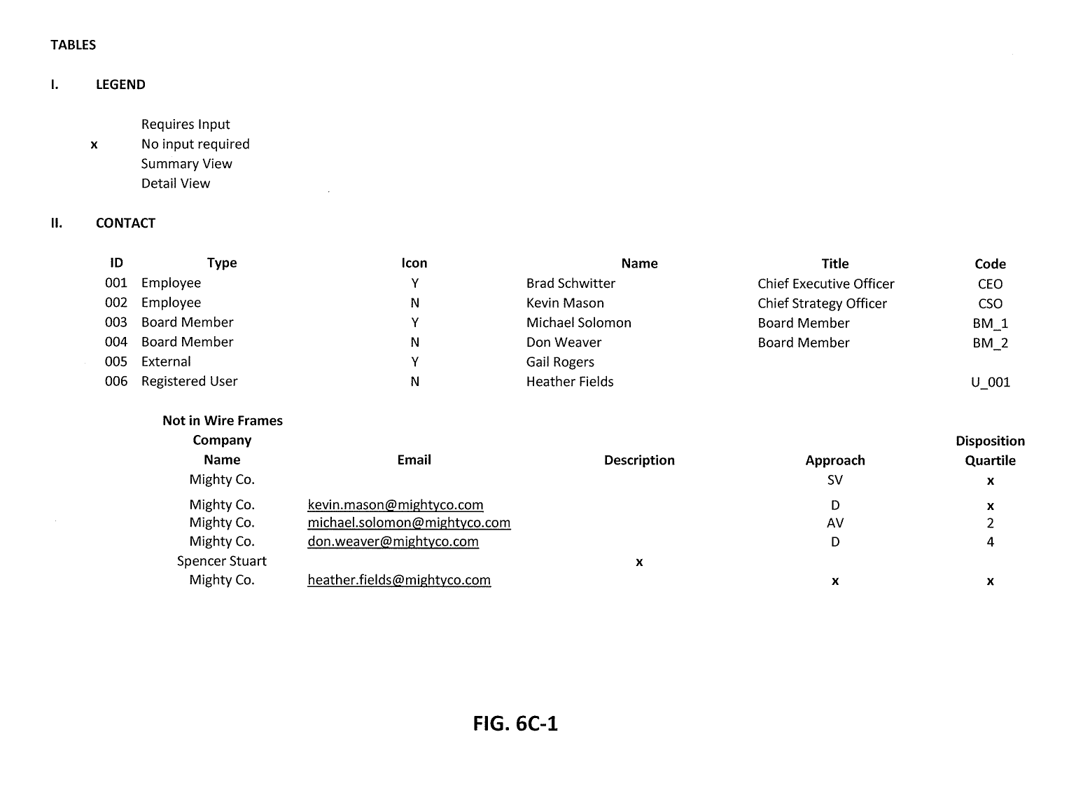

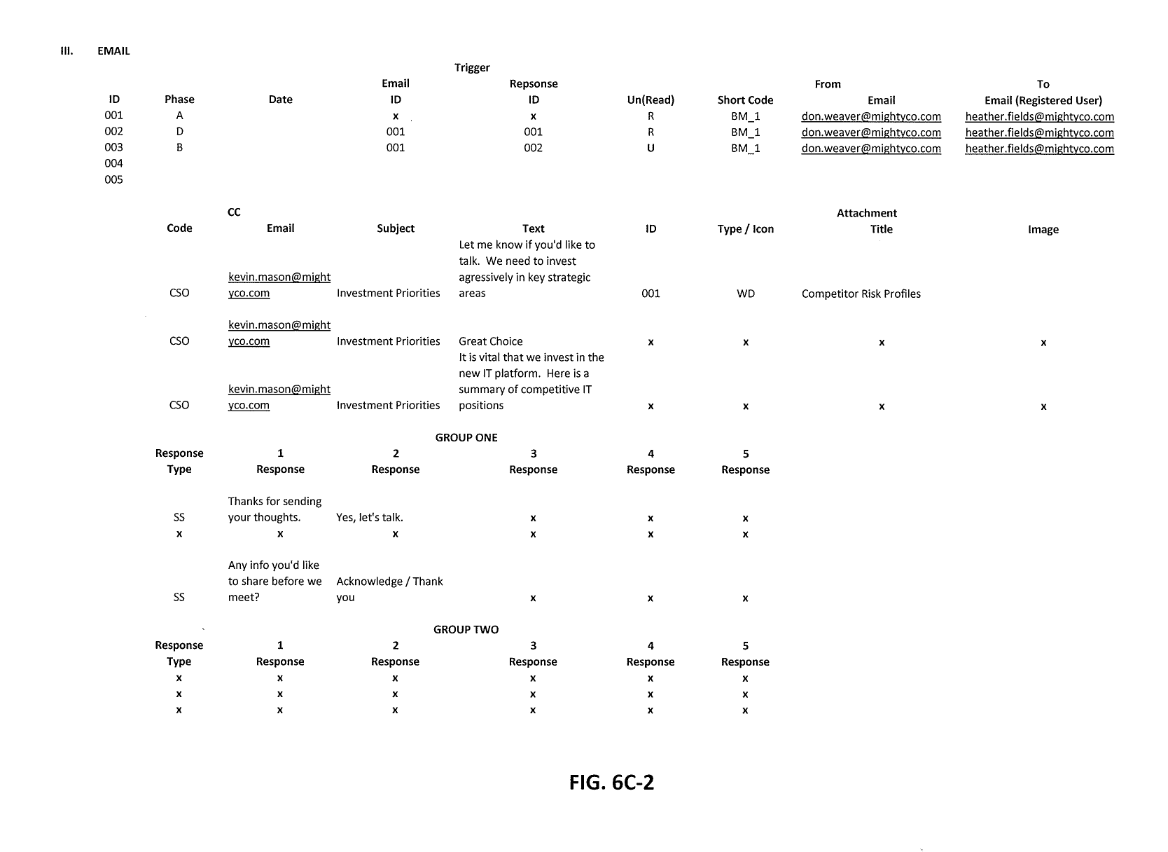

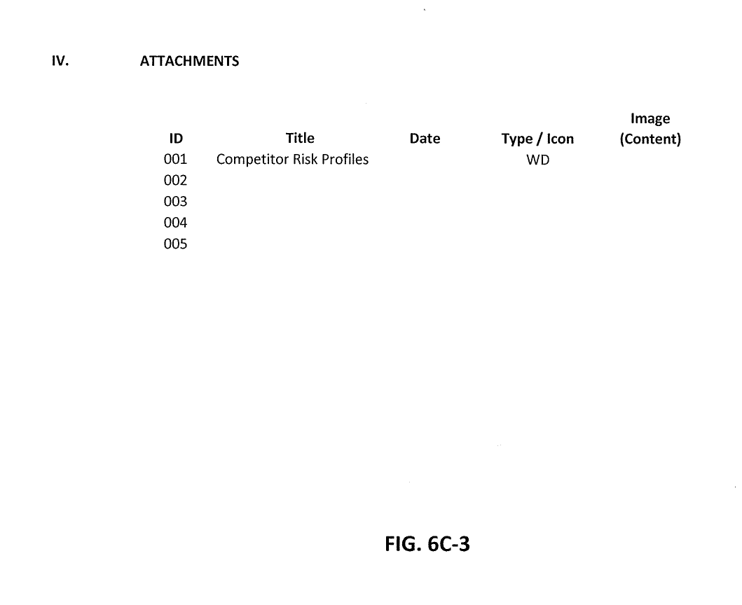

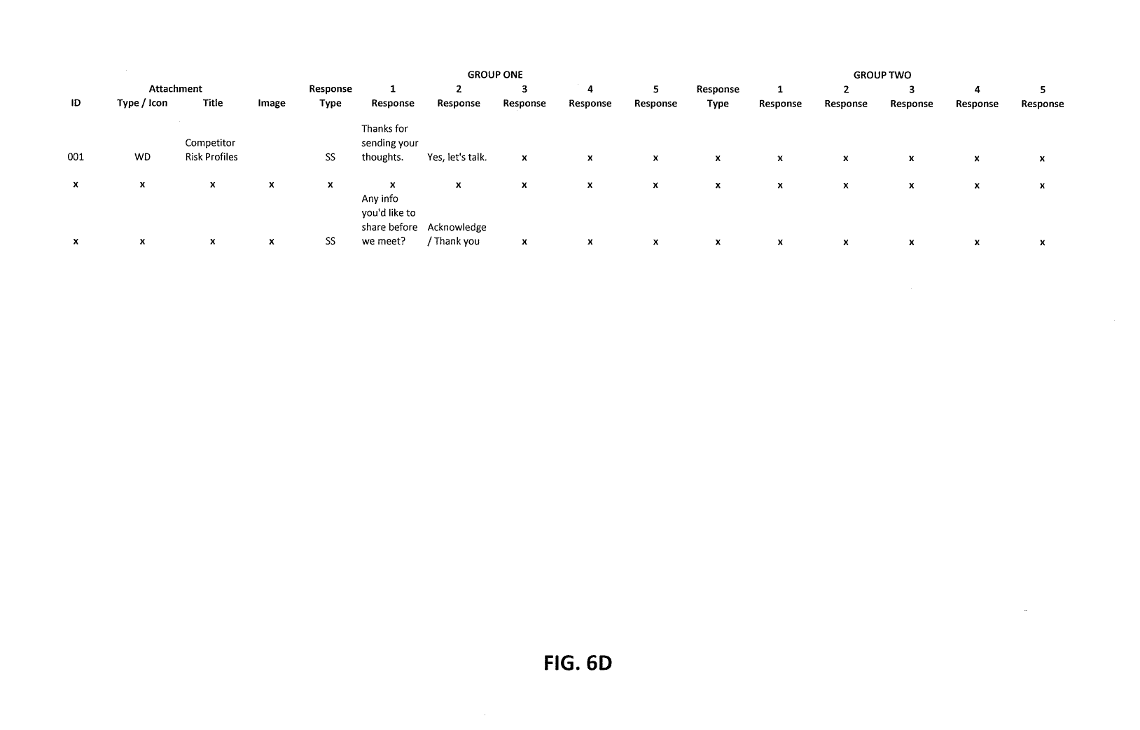

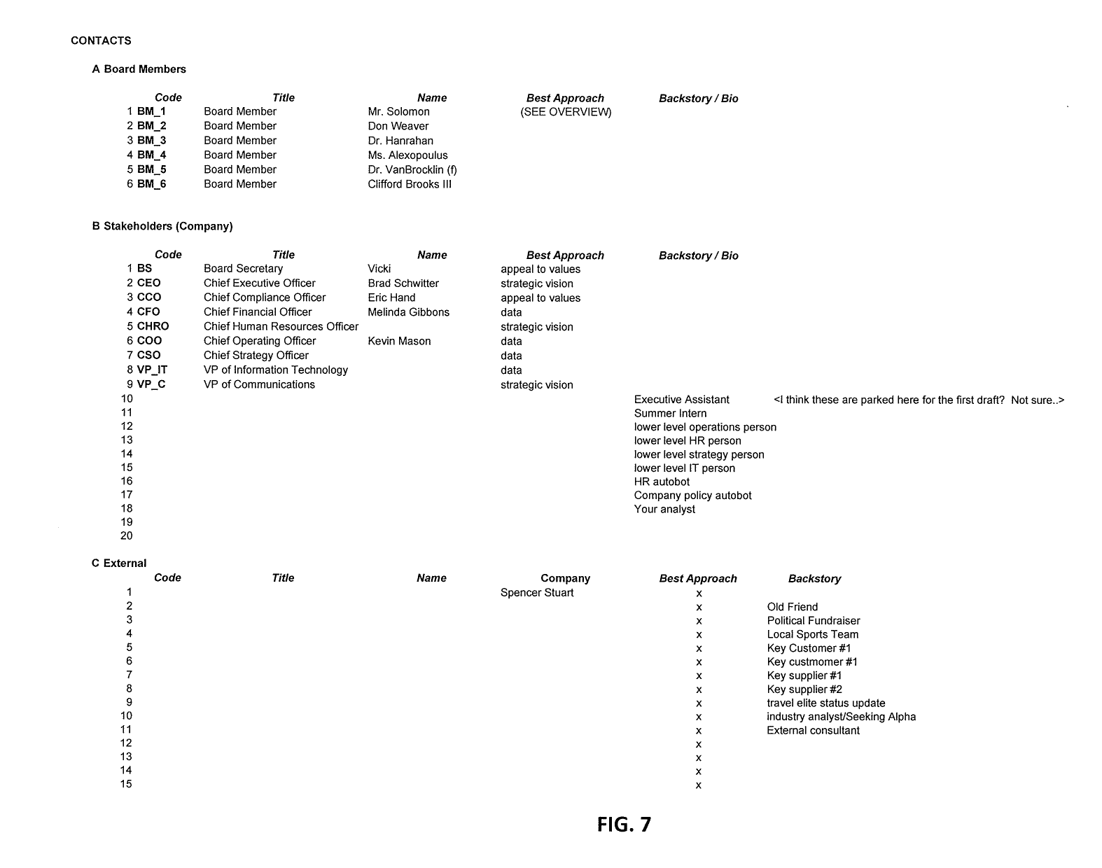

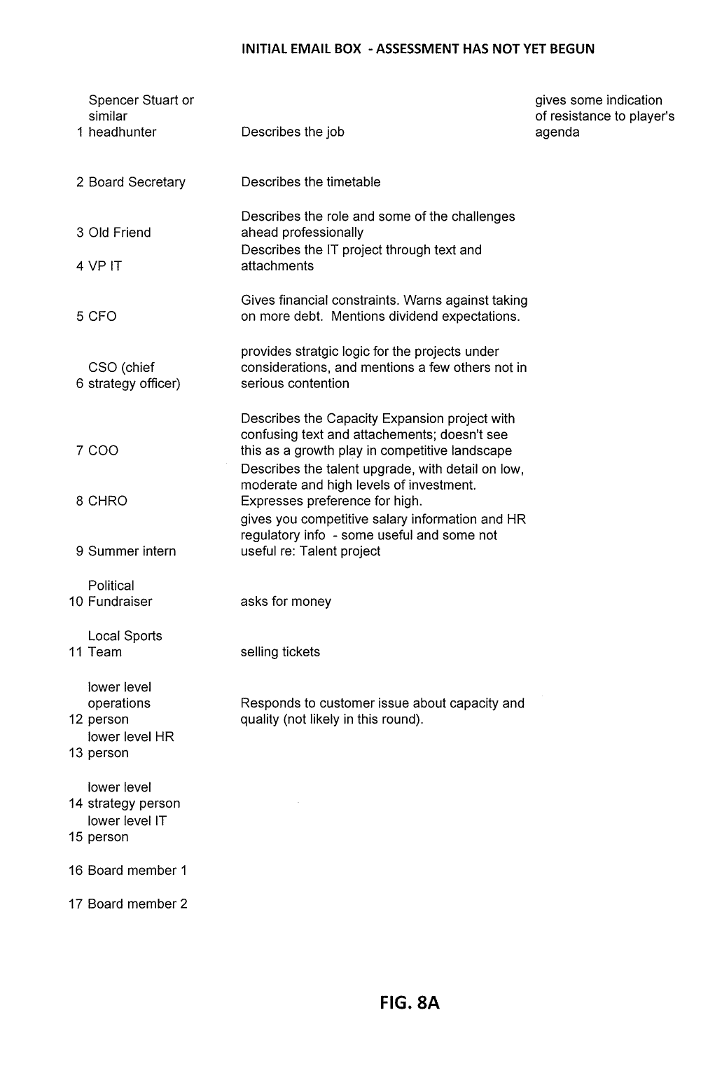

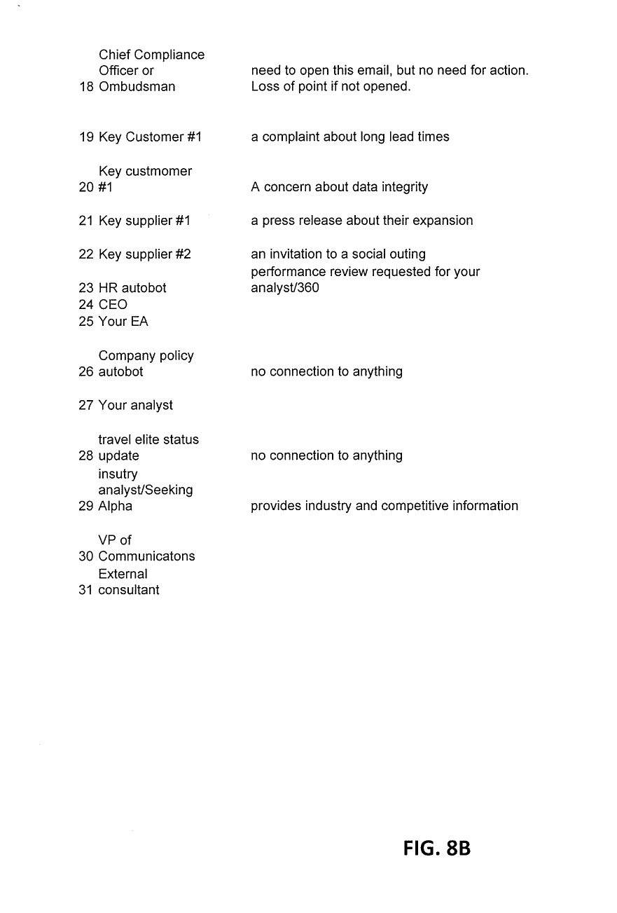

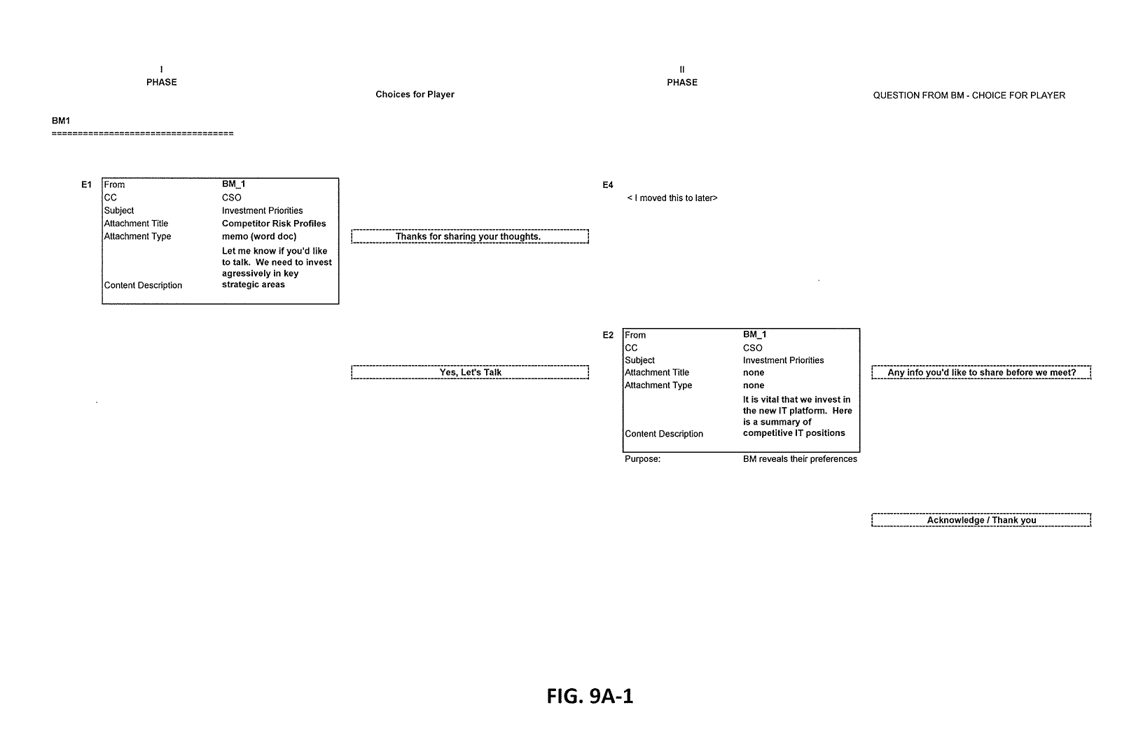

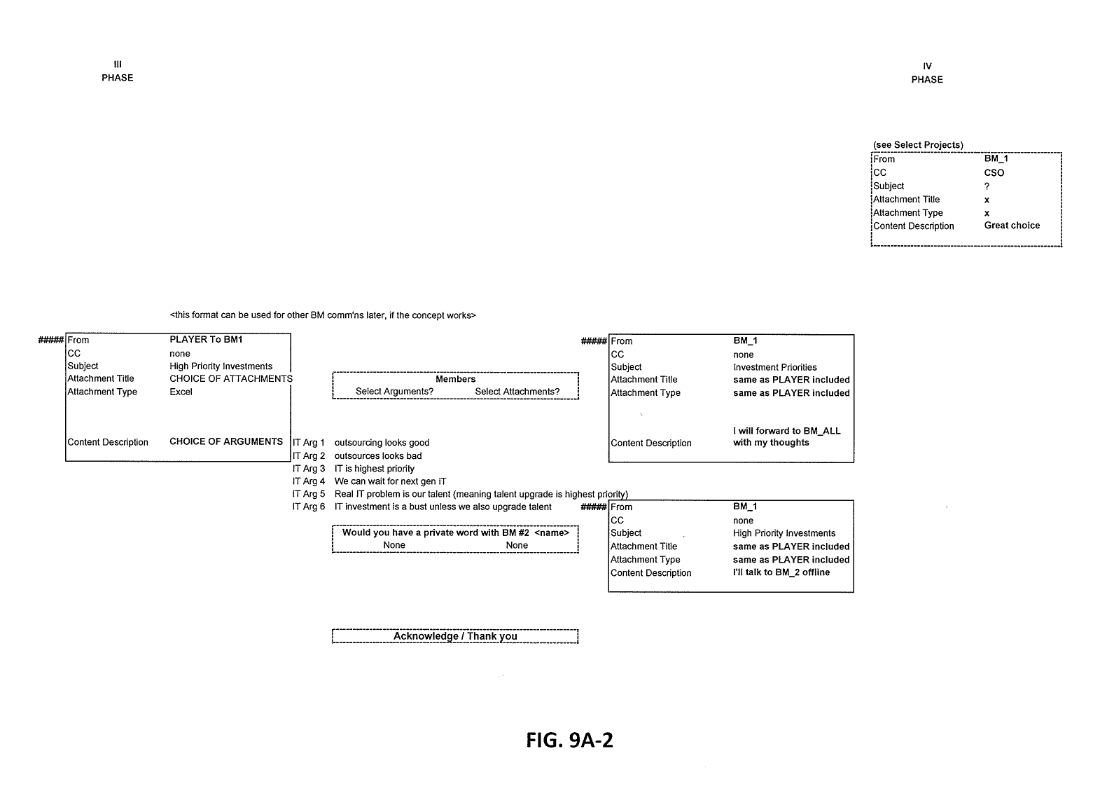

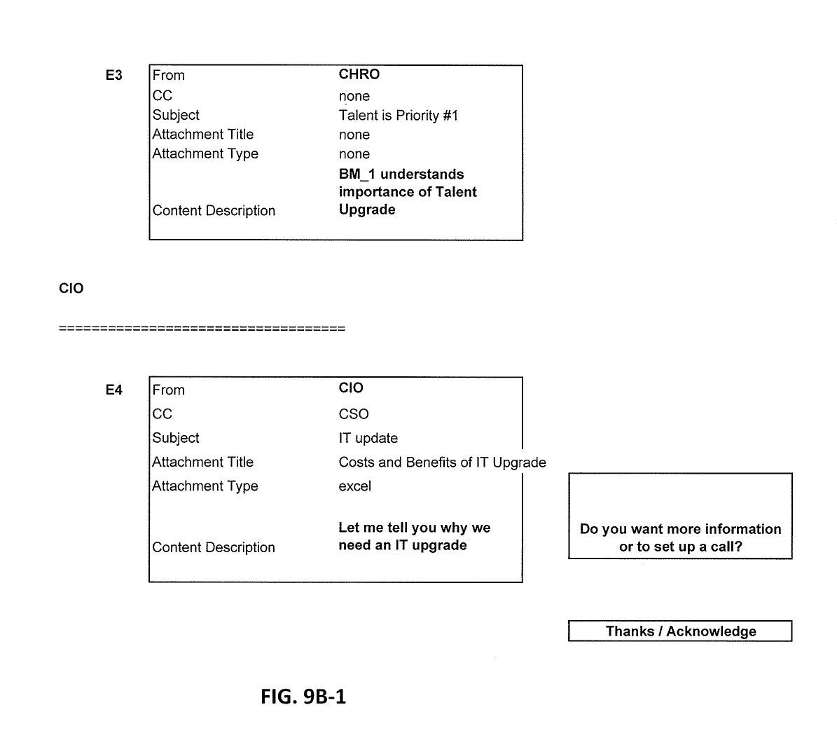

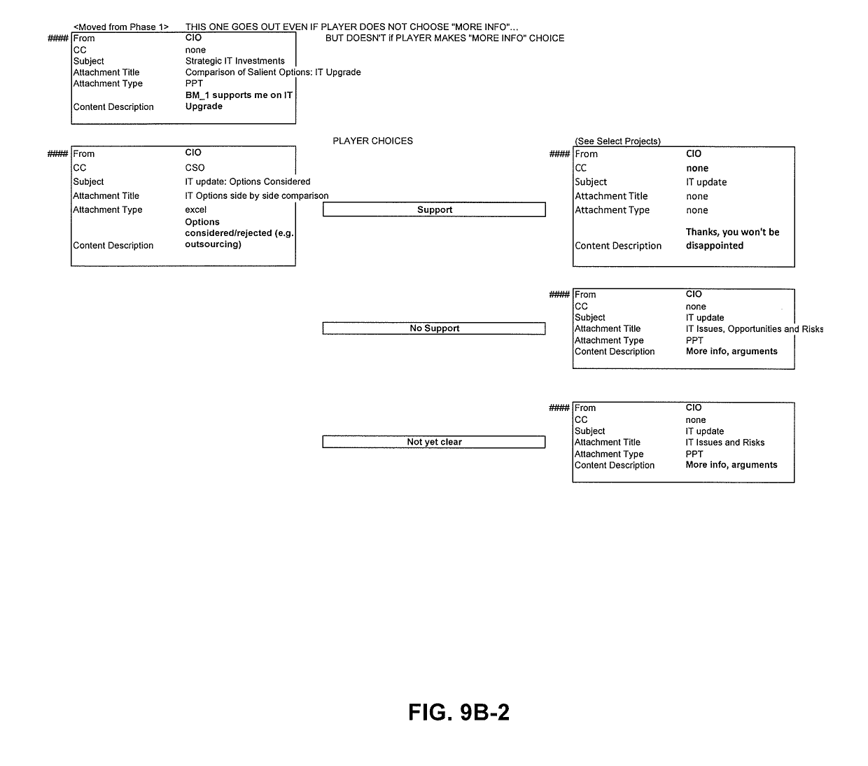

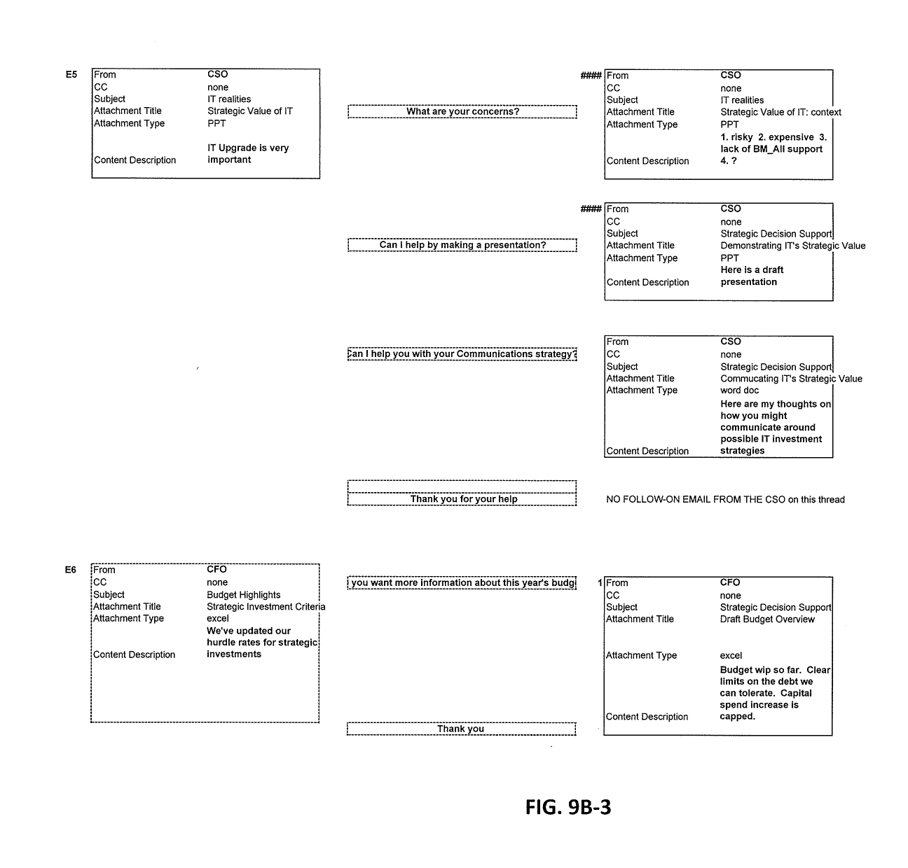

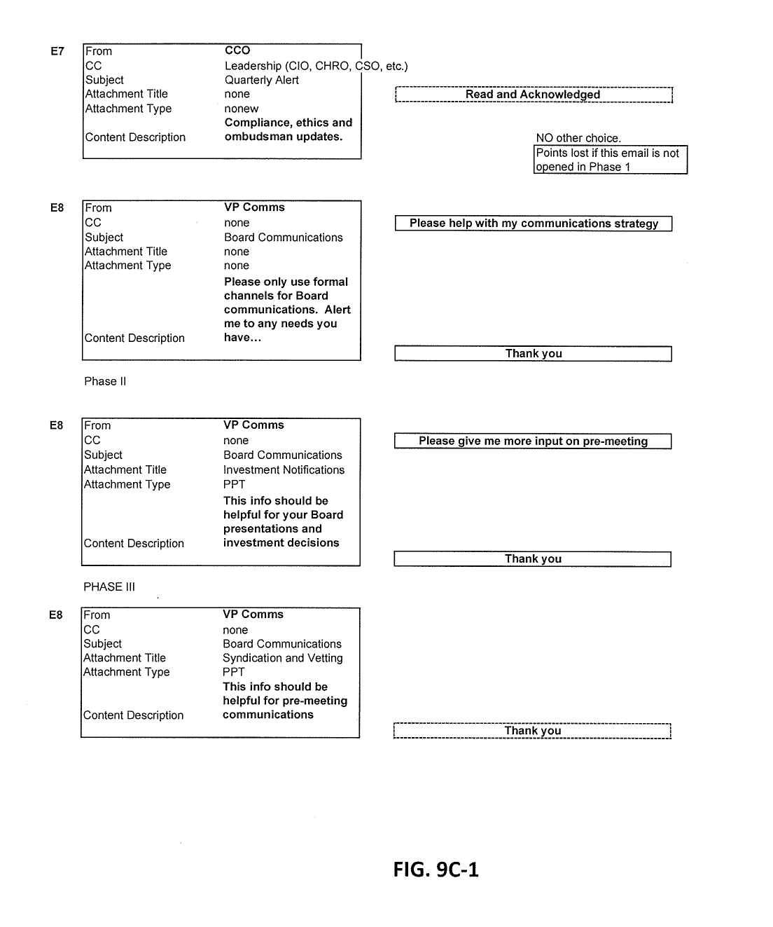

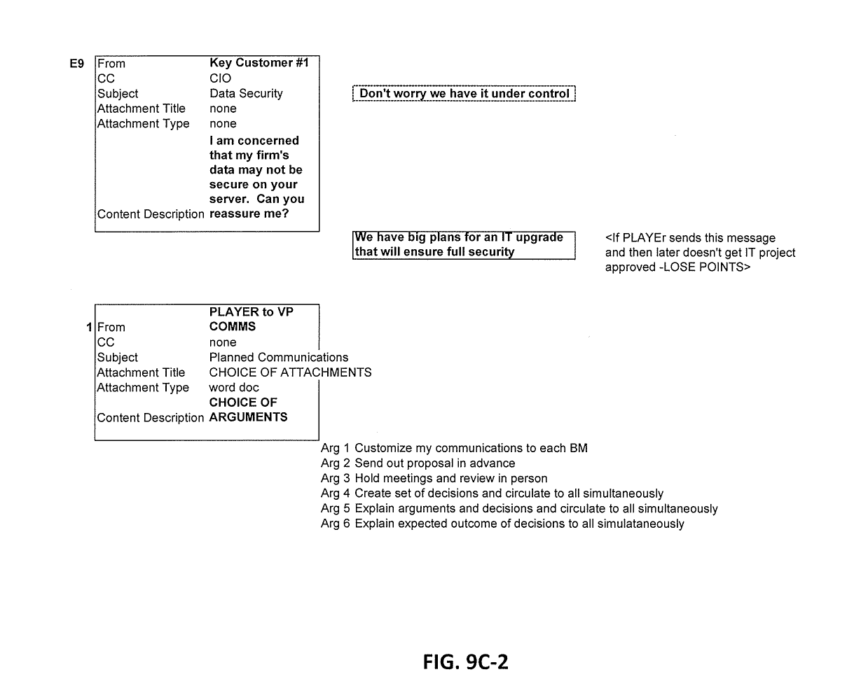

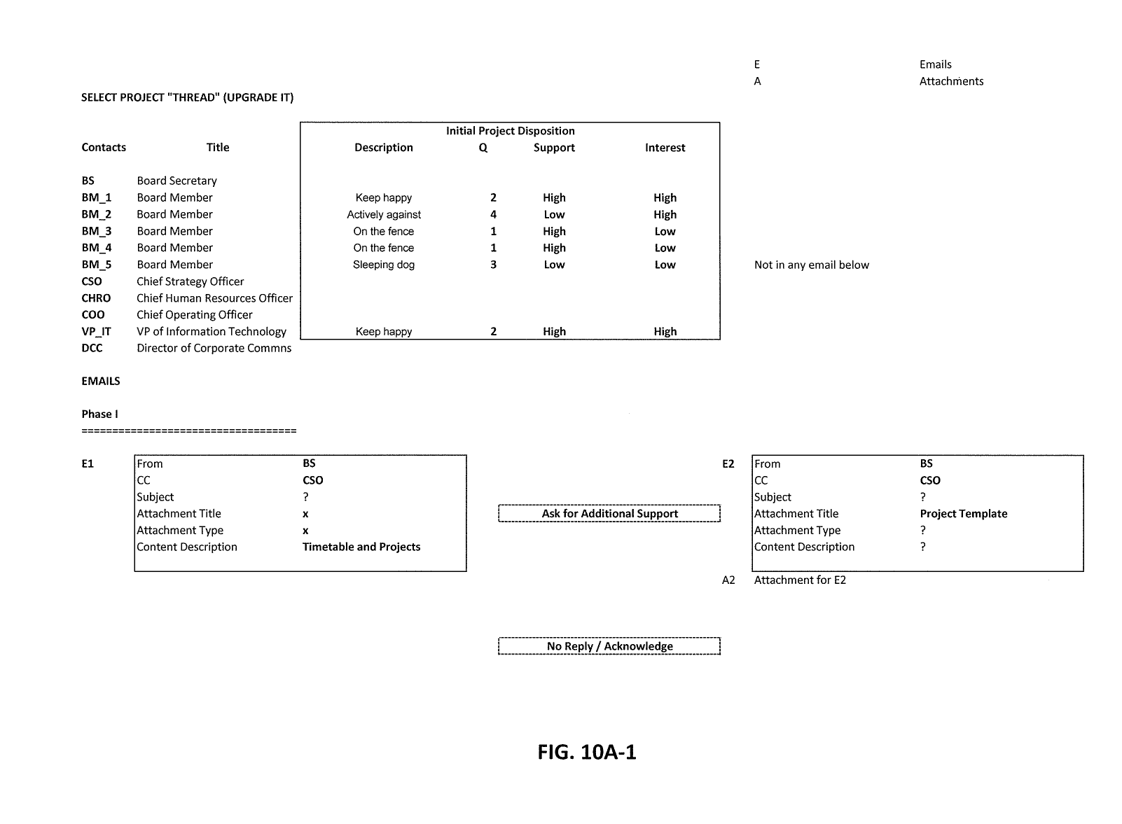

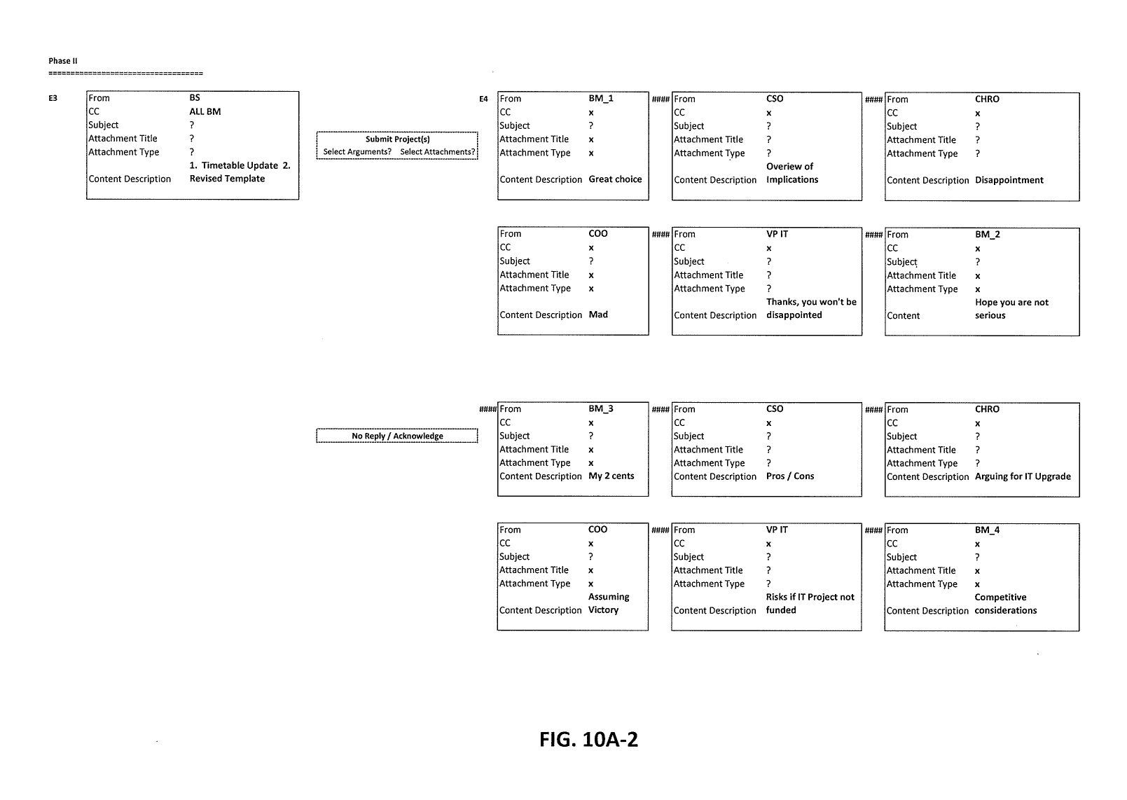

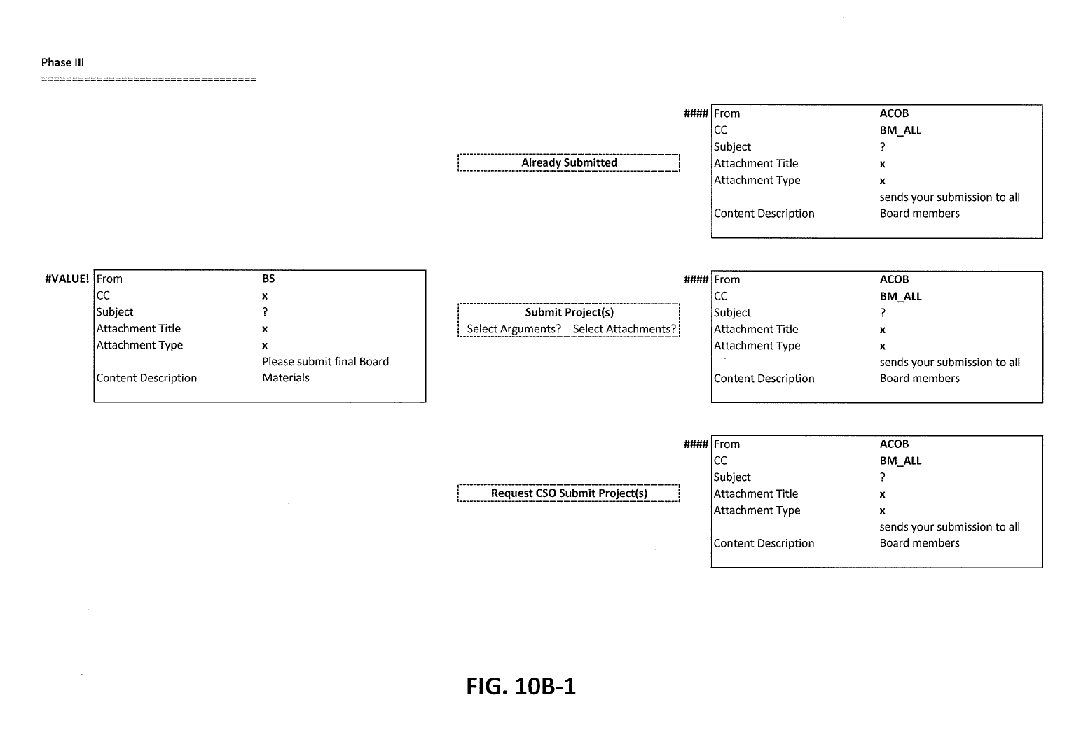

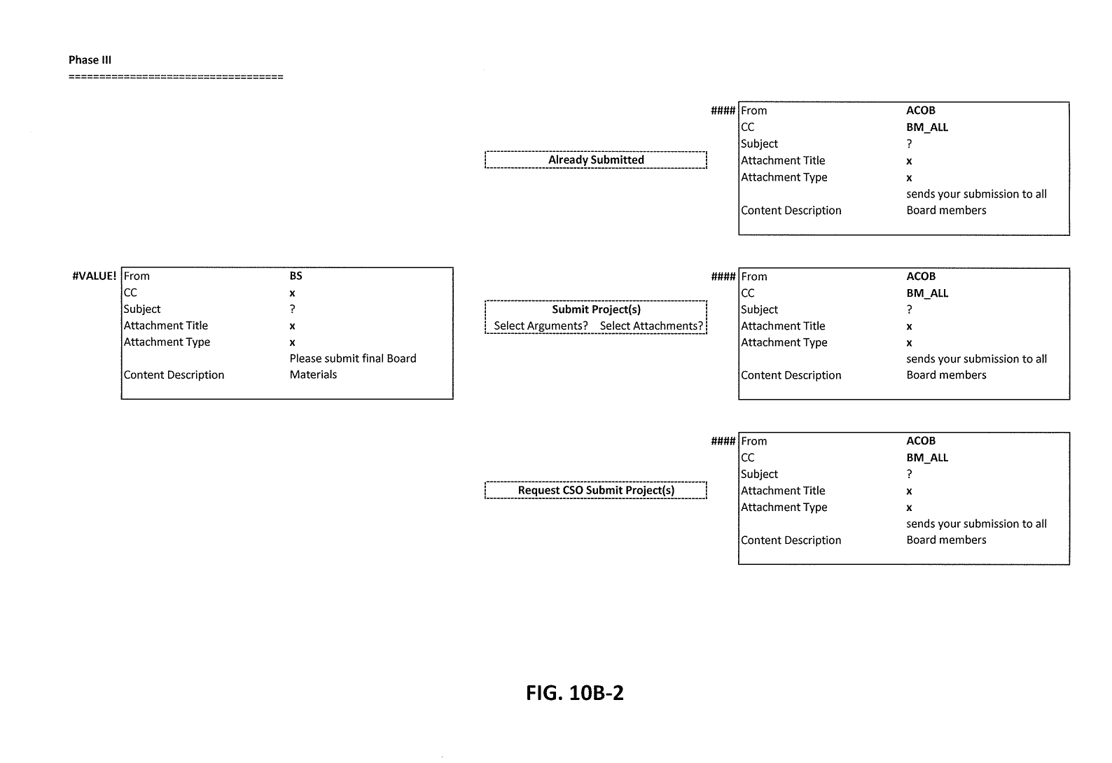

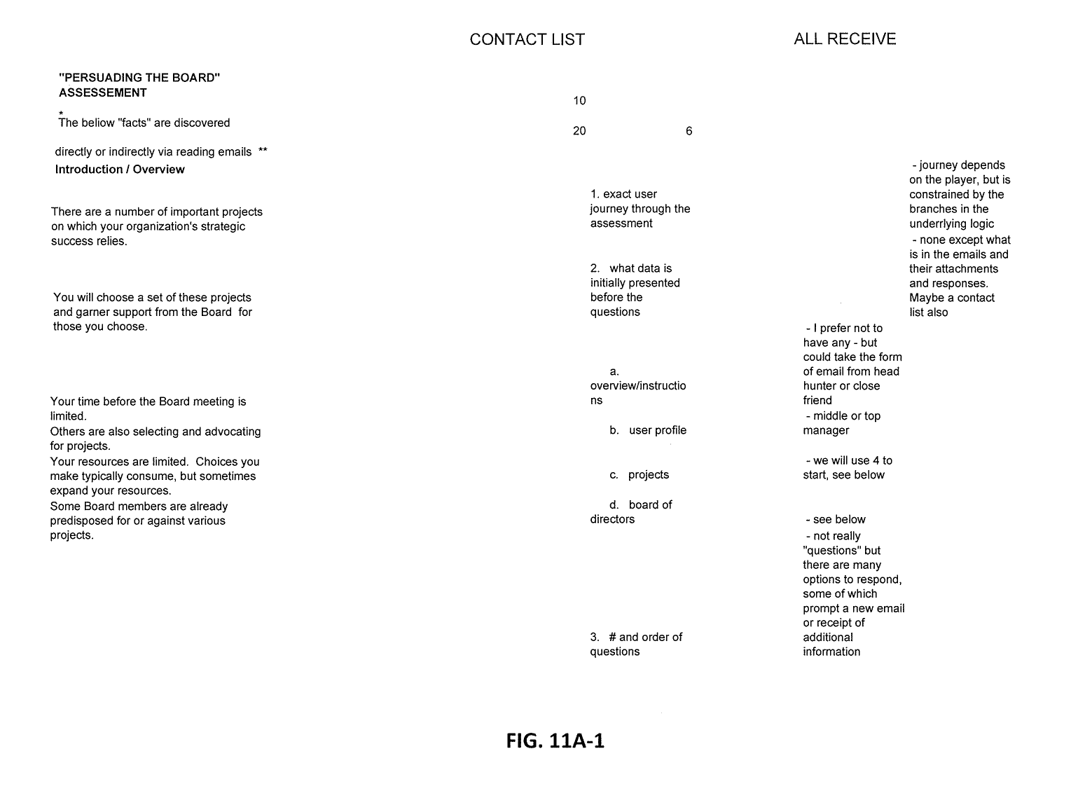

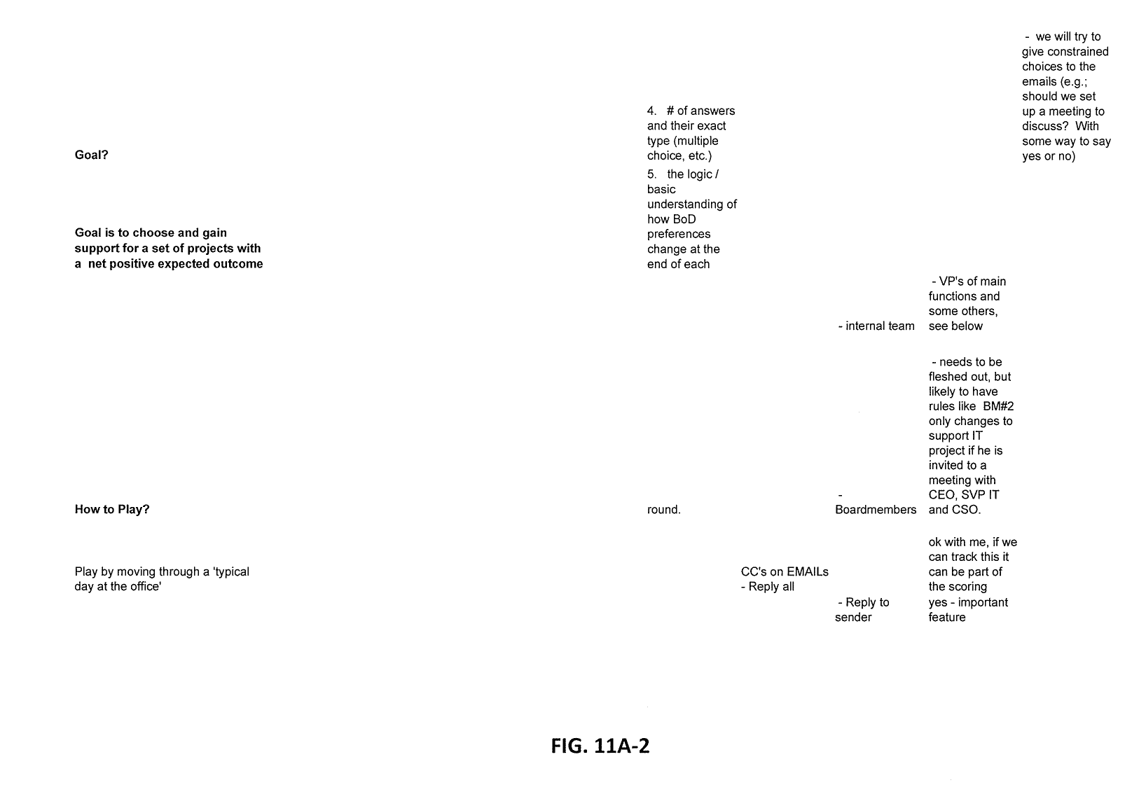

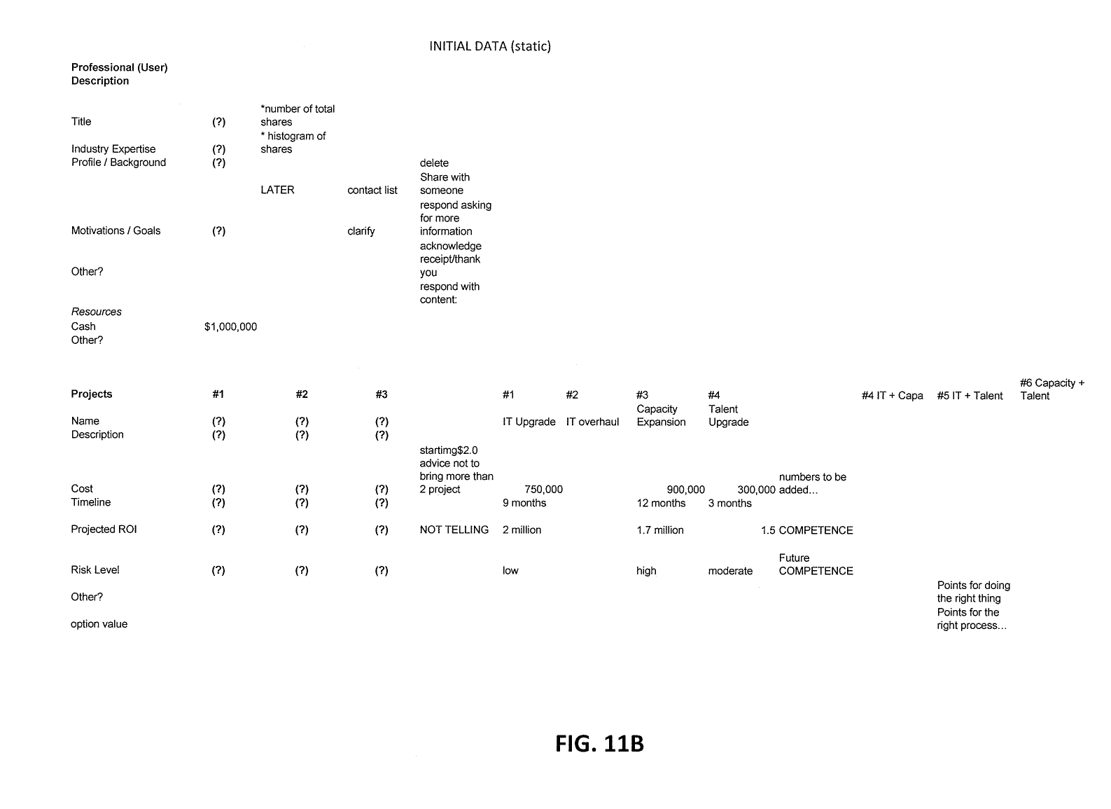

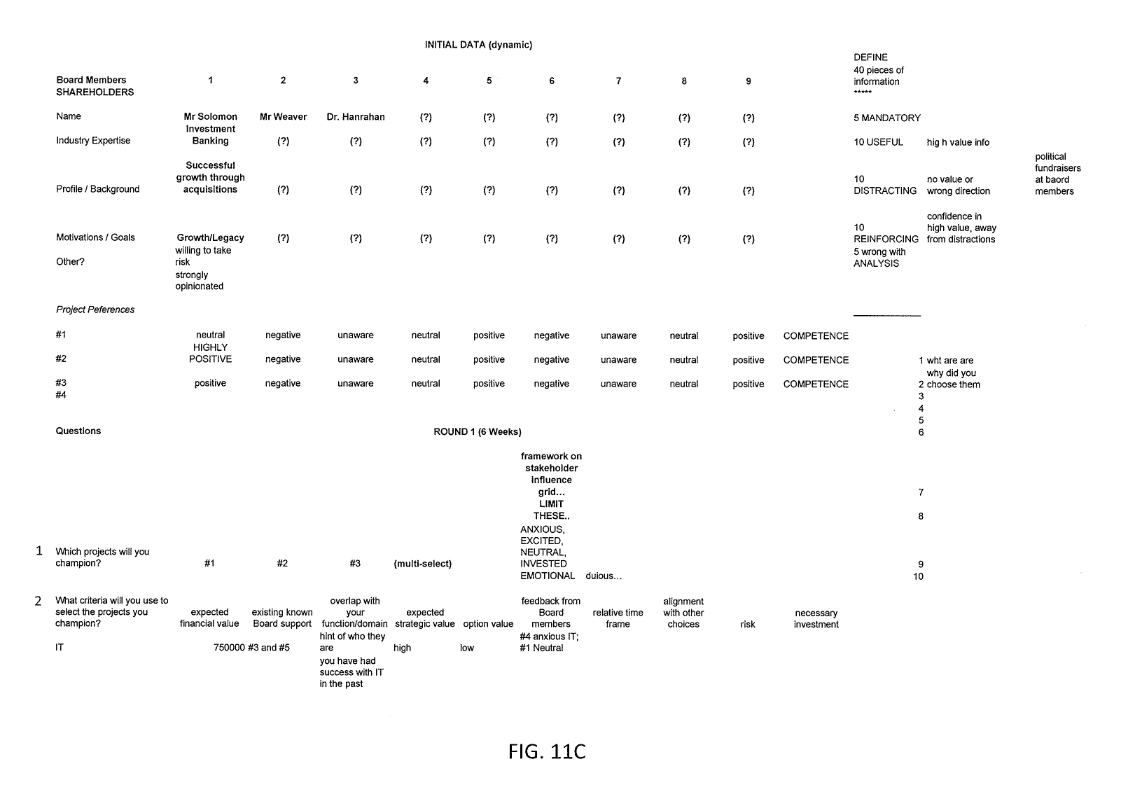

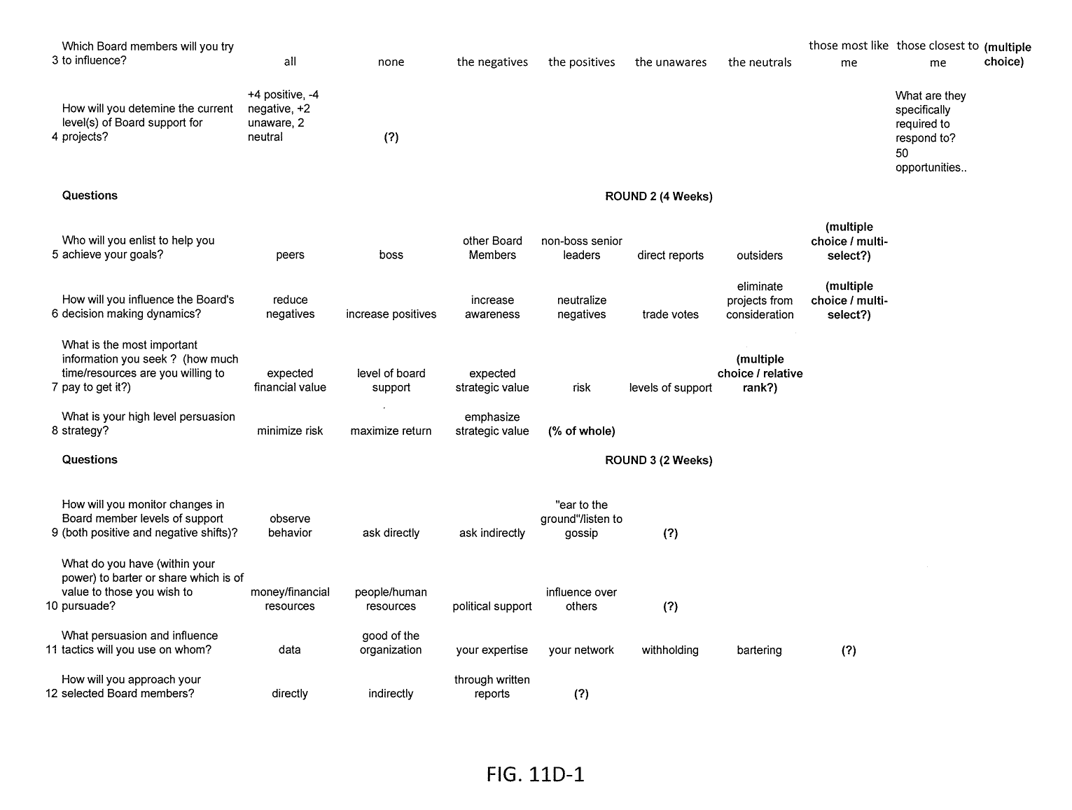

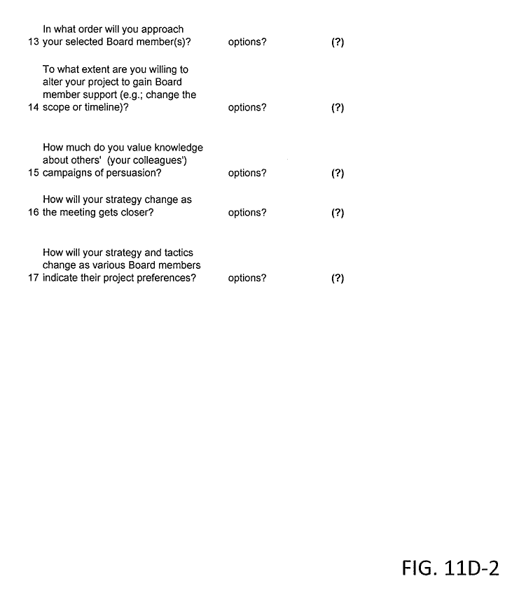

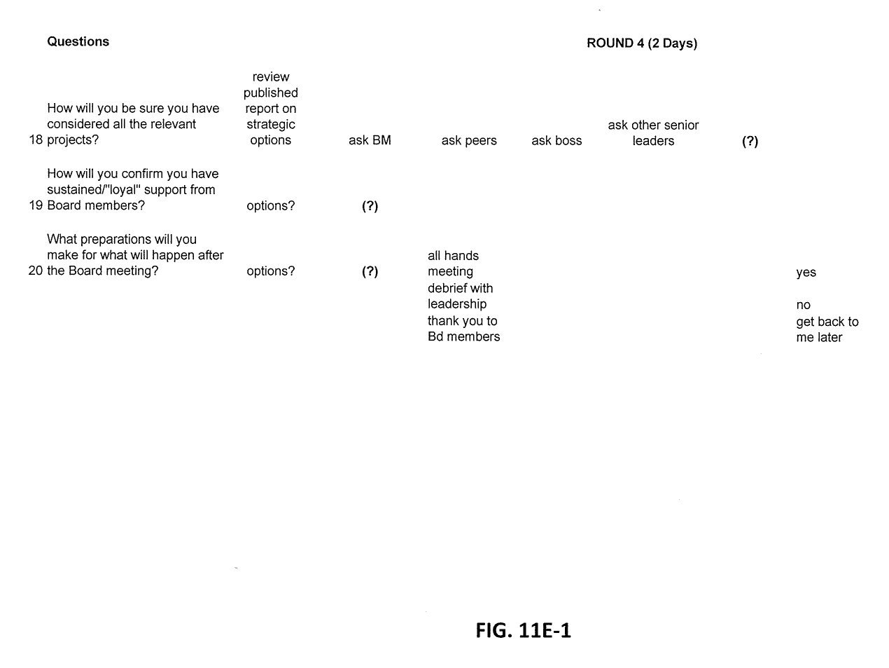

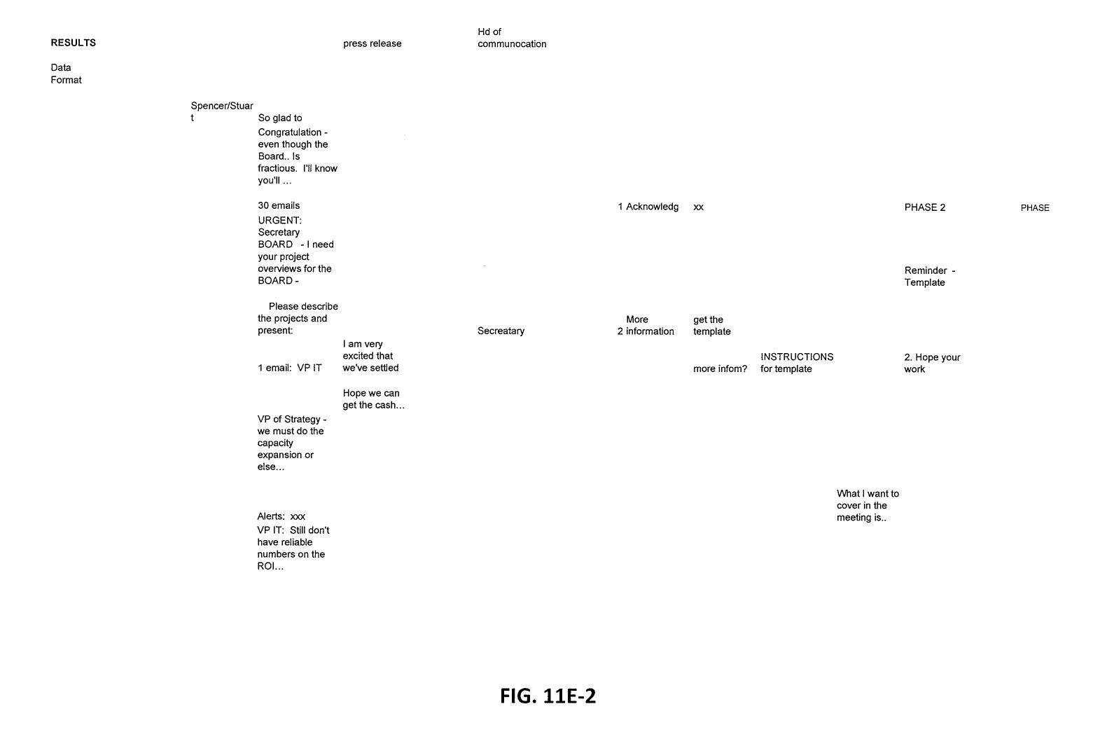

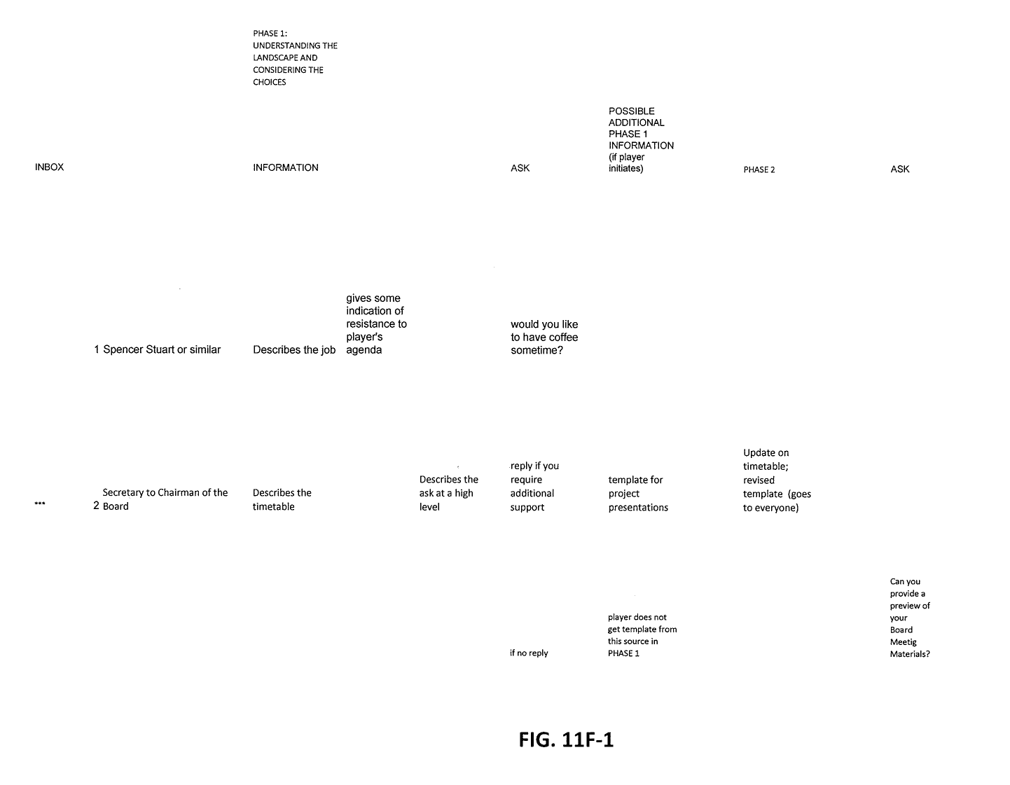

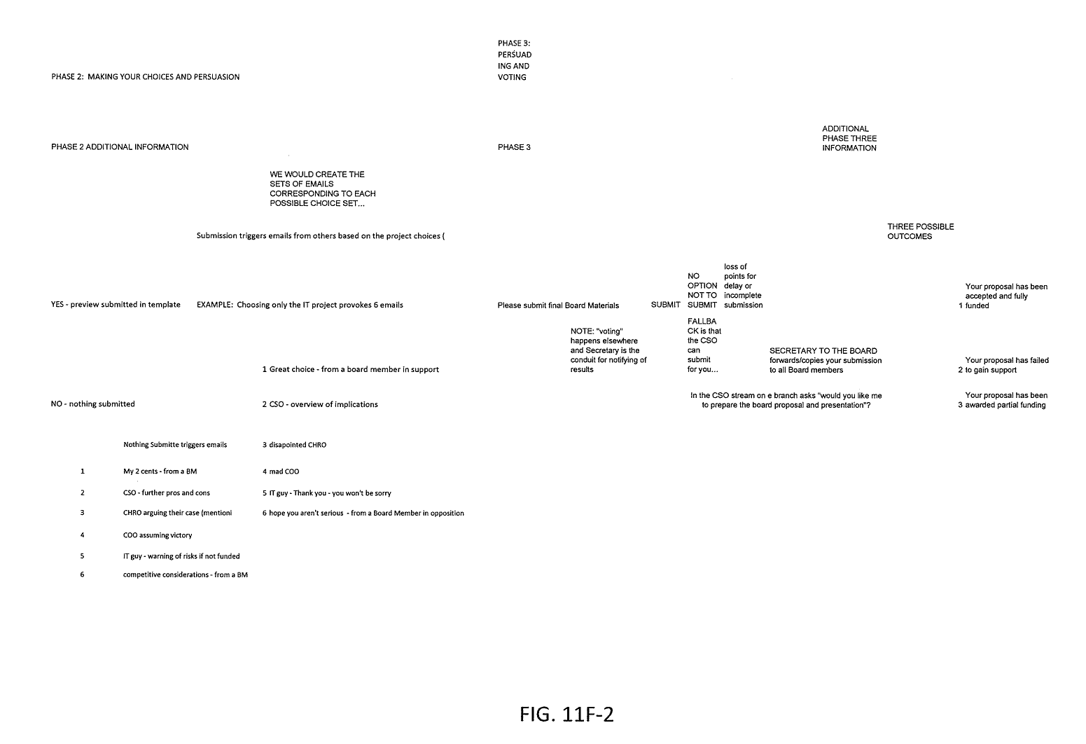

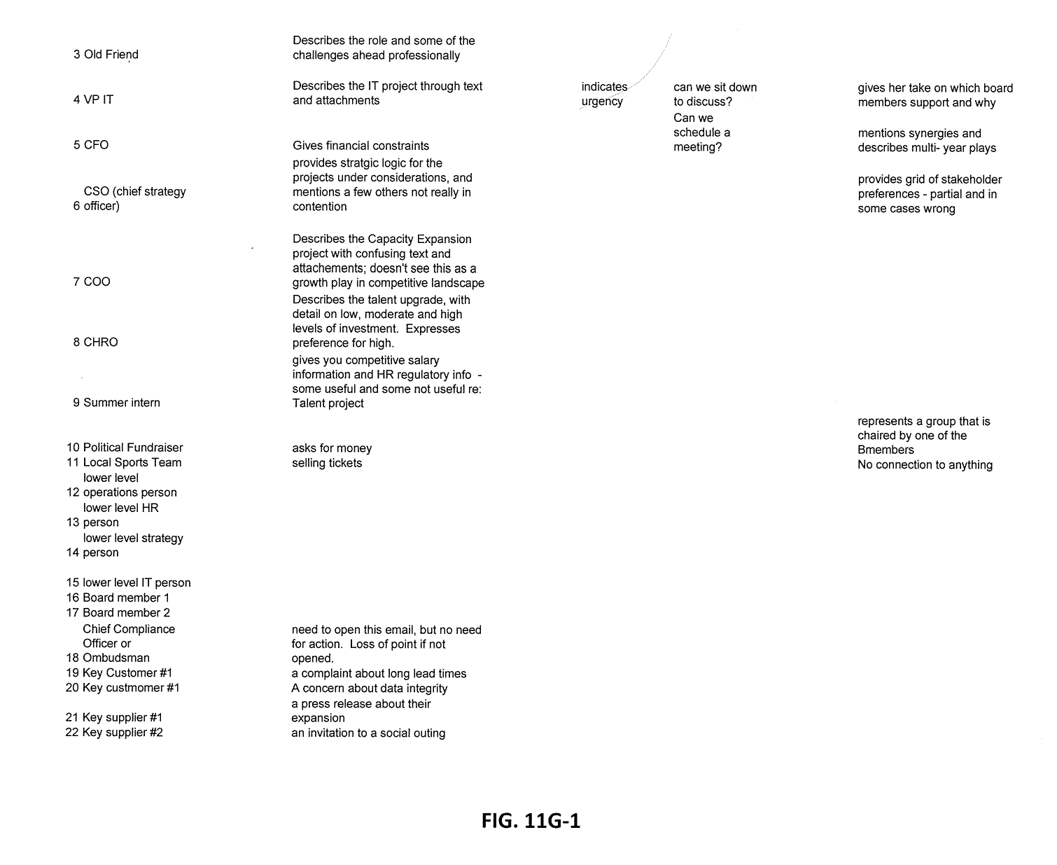

As shown in FIGS. 1-11G, in one embodiment a skills assessment system is provided to generate a realistic business environment, such as a plurality of incoming and outgoing messages that may be considered in an effort to resolve an umbrella topic (e.g., Influencing the Board). The composite elements of this umbrella topic are challenges that the participant encounters as information flows into the participant's communications channels (e.g., email box, Slack, Twitter, Sharepoint, Dropbox, VoiceMail or other communications channels). Based on the responses of the participant, additional information (e.g., data, different questions, conflicting information, validation) and/or new challenges are generated that are consistent with the objective of that particular experience and with realistic business practices. The participant is quickly engrossed, and has access to information that the participant may consider in determining what the best responses will be, such as a directory of employees and key stakeholders (e.g., Board members), analyst reports on the organization, and other information. The resources utilized by a participant, including the resources provided but not utilized by a participant, may be noted in a debrief with the participant after the experience is concluded.

Thus, in one embodiment, an assessment experience is made up of a set of challenges. These challenges are drawn from different knowledge domains (e.g., critical thinking, data analysis, strategic communication, etc.) and vary in length and difficulty. Solving challenges individually or sequentially is similar to conducting a business case or a role play. However, being faced with a set of diverse challenges, to which more challenges are added over time and different challenges are confronted based on the participant's responses, provides a more realistic analysis of an individual's qualifications and capabilities and is more akin to real-world encounters for managers and C-suite employees. The system is able to watch the participant as the participant prioritizes and addresses these diverse challenges along with a set of distractions (e.g., retirement parties, ethics compliance and one-off requests for responses). Based on monitoring the participant, the system may provide feedback to the participant on the participant's strengths in various business knowledge domains, ability to address business challenges consistently and using established best practices, stylistic preferences and expressions of creativity/intuition, reliance on hard data, reliance on personal networks, pattern recognition (e.g., soft or incomplete data sets) and relative ranking versus other assessment participants.

A skills assessment system may include an online interface providing front end access by the participant to the system. The system may also include a database of challenges, each challenge having a set of multiple (e.g., at least four) possible responses. For example, the database of challenges may be a set of problems to be solved (e.g., determine the cost of a new product or inform the appropriate people about a change in process). The challenges may vary in difficulty, length, number of possible solutions, amount of varied information accessible by the participants and knowledge domain. A challenge difficulty may be provided as novice (easy), manager (moderate) or expert (difficult). A challenge length may be provided as short (challenge resolved in three moves or less), medium (challenge resolved in four to eight moves) and long (challenge resolved in more than eight moves). The number of possible solutions may be provided as single, multiple and numerous challenges. For example, a single solution challenge may have only one appropriate solution, such as legal or procedural challenges where there is only one correct response (e.g., do we pay severance to an employee under X conditions?). A multiple solution challenge may have two to four appropriate solutions, such as any of a risky solution, a conservative solution, a collaborative solution, a competitive solution and a hybrid solution (e.g., under what conditions would we use a joint venture to enter a new geography?). Numerous solution challenges may have five or more appropriate solutions which may reflect personal or stylistic preferences (e.g., where should we hold our company retreat?). Knowledge domains may include any of critical thinking, strategic communications, ethics, cybersecurity, entrepreneurship and the like.

Each challenge in the database has a root question, but the challenge may not directly ask this question. For example, instead of asking “Where should we hold our company retreat?”, the challenge may begin with “Joe wants to go back to the golf resort we used in 2012 for next year's retreat. Ok by you?”. Thus, the database may contain root questions (e.g., usually not posed as a direct question), conversation threads (e.g., conversation prompts, responses to conversation prompts) and categorization of difficulty, length, number of possible solutions and knowledge domain.

One or more algorithms may be provided for selection of challenges that make up an assessment (e.g., an assessment experience). For example, the algorithm may include consideration of the most important skills and behaviors needed to succeed in a management role (e.g., decision making under uncertainty). Templates of dominant skills sets, competence maps and domain expertise may be used to identify and tag these skills and behaviors (e.g., analysis of complex financial data may be important for a Chief Financial Officer but not for a Chief Human Resources Officer). The algorithm may also include consideration of examples of high performing managers demonstrating these skills, as well as the most common mistakes that managers make (e.g., overestimating or underestimating uncertainty). For example, common mistakes may be provided by experts in the field and/or by business school professors, which may be augmented and/or validated with data from previous skills assessment participants on the most common mistakes that participants make within assessment experiences over time. The algorithm may also include consideration of academic or other research or theory to guide management decisions (e.g., 4 levels of Uncertainty; HBR Article with framework and best practices; MBA textbooks; articles and books by business gurus).

As another example, the algorithms and determinations for presenting the challenges begin with an initial challenge to start the assessment experience. Additional challenges are added either at a given time interval (e.g., every 10 minutes) or when the participant makes a response that triggers a new challenge. New challenges may be added at any time in the assessment experience. For example, in a “Drinking from the Fire Hose” assessment experience, a large number of new challenges and new data are introduced 10 minutes before the time limit of the experience, forcing the participant to prioritize and triage efficiently to get the value from the experience. Assessment experiences may be time bound, where the participant is told the timing at the outset and receives reminders halfway through and at 10 minutes before the expiration of the time limit. Once the time expires, the participant cannot make additional scorable responses. Varying timing may also be one of the features. For example, the participant is initially given one hour to complete the assessment experience, but once the participant starts completion of certain challenge, other challenges may be required in less than an hour. The score may then reflect how responsive the participant is to this new set of constraints.

The skills assessment system may also include a module for tracking and evaluating the participant's decisions during the assessment, a scoring module for aggregating the participant's decisions into a composite score reflecting a level and type of business acumen, and a reporting module for generating reports. For example, tracking may include the order in which the participant attempts the challenges and the time the participant spends on the challenges. Tracking may also include whether the participant immediately responds to the challenge prompt or whether the participant reads it and responds later (e.g., after examining other inputs or searching for helpful information). Tracking may further include the participant's individual responses to challenge prompts and the sequence of responses in every challenge (e.g., the participant may get off to a slow start on one of the challenges, but then have an insight or analyze some data and shift into a more effective set of responses). Tracking may also include the difference between the sequence of responses the participant uses and a determined ideal sequence of responses for a Style. For example, in one challenge, a data driven participant may complete the challenge in six steps, acquiring and using three types of data, while a relationship driven participant may complete the same challenge in eight steps, acquiring and using inputs from five different colleagues and experts. Tracking may further include the participant's ultimate recommendation to conclude the assessment experience. Each assessment experience has an umbrella domain (e.g., Managing a Public Relations Crisis, Influencing the Board on Large CapEx Proposals, Allocating Bonuses, Deciding whether to Fund a New Venture, etc.) The participant is only given the guidance that they need to address this umbrella topic. However, while the participant is “Deciding whether to Fund a New Venture,” for example, the participant is actually confronted with challenges of navigating the political landscape, decision making under uncertainty, assessment of risk, strategic communication and financial analysis. The reporting may then tell whether the participant made a good recommendation, which knowledge domains the participant was strongest in and what style the participant demonstrated.

The assessment experience may be an online immersion experience where the individual being evaluated participates in a realistic scenario in which the participant answers a series of questions in order to obtain an unbiased assessment of the participant's performance in business situations. For example, the assessment experience may provide control to the participant for selection of which elements of the business environment to approach (e.g., which emails to read or which meeting invitations to accept) and the order of the approach. The participant's selection of which elements of the business environment to approach/select and the order of the approach/selection may then be evaluated and input to an assessment report. Further, selection of which elements of the business environment to approach/select and the order and type of incoming information and evaluative questions may change in a real-time dynamic manner dependent on the actions of the participant. For example, the amount and type of information presented to the participant (e.g., emails, voice mails, calendar invitations, meeting requests, etc.) may be different depending on a participant choosing a first approach or a second approach. The reported scores may be compared across populations of participants to provide relative rankings and descriptive statistics on desired information points, such as the participant's mastery of knowledge domains, the participant's approaches to problem solving (e.g., intuitive, data-driven or creative) and changes in the participant's performance over time.

A talent assessment scheme is provided for monitoring and evaluating individual reactions to complex business situations when target individuals (e.g., participants) are provided with a series of choice sets of plausible responses under conditions including time, resource and decision constraints through the online interface. These reactions are converted to scores and performance metrics that are intended as inputs to talent management decisions. The system creates dynamic business experiences/situations by selecting challenges from a bank (e.g., stockpile) of challenges that are tagged according to a labeling system and compiled using one or more algorithms. The participant's responses trigger selection of additional challenges and choices, such that each individual participant completes an assessment shaped by the participant's own inputs. The scheme is thus a customized, individualized assessment for the participant that can be provided to the participant and/or hiring entities interested in promoting/developing a current employee or hiring a job candidate.

A scoring system normalizes the varied experiences and provides for comparable scores to be generated across individuals and populations. For example, if two people complete the “same” assessment experience, they will actually have different experiences, as each participant's responses will prompt different subsequent challenges, and each participant will likely choose different pathways to reach the ultimate umbrella recommendation. Thus, the system may normalize the scoring by challenge to adjust for these differences. In this way, while the participant may believe the participant is answering a lot of multiple choice emailed prompts, the participant's individual answer to any given prompt is not being scored on its own merit. Organizations may highly value the ability to differentiate across the organization's talent pool, not only to understand who has what skillset (e.g., CPA, MBA), but to identify who/what percentage exhibits which style (e.g., creative/intuitive) and how much diversity the organization has in its workforce in terms of problem solving approaches, response to stimuli, deference to power and other business features.

The scoring may reflect not only the choices made in response to any individual prompt, but also the sequence of choices made, the specific combinations of choices made (whether made in sequential order or not) and the selection of one or more super-ordinate choices that change the weighting of the scoring rubric. In one embodiment, the overall score may have four parts. In the first part, a percentage of the score is based on the participant's recommendation in response to the umbrella topic at the core of the participant's particular assessment experience (e.g., Persuading the Board). For the second part, a percentage of the score is based on the extent to which the participant arrived at a/the correct solution of the challenges the participant faced (e.g., a composite of 15-20 challenges encountered in the Persuading the Board Experience). In the third part, a percentage of the score is based on the priority the participant placed on various challenges (e.g., did the participant choose to read the party flyer before the message from the CEO?). For the fourth part, a percentage of the score is based on the consistency with which the participant approached the overall experience. For example, consistency does not mean one size fits all. A participant who consistently takes more risk when the likely returns are higher and less when likely returns are lower may seem “inconsistent” when it comes to risk taking. However, the system is able to see the bigger picture and measure the participant's consistency on applying an important risk/return business rule. The percentages may be varied according to client preferences and role (e.g., top leadership roles may weight consistency higher, middle management roles may weight challenge solutions higher and consulting roles may weight umbrella recommendations higher). For example, a standard setting may be 25% umbrella recommendation, 40% challenge solutions, 20% prioritization and 15% consistency.

Within each knowledge domain a separate score may be computed based on the extent to which the participant arrived at a/the correct solution of the challenges the participant faced in that domain. For example, in the “Persuading the Board” experience a participant may have confronted six challenges in the domain of strategic communications. The participant's responses to these six challenges would be separately reported, as would the other knowledge domains encountered in the participant's assessment experience.

The participant's style may also be monitored and/or determined based on the assessment experience to generate style feedback. For example, the participant's process of arriving at solutions to the challenges may be data driven, creative/intuitive, relationship driven, pattern driven, or indeterminate (e.g., showing no distinguishable attachment to any single style).

The system generates a set of reports usable by human resource professionals or automated human resource systems in talent management. In one embodiment, these reports are portable across organizations and industries, and contribute to the earning of badges/credentials after mastery is demonstrated in a series/set of knowledge domains. For example, performance metrics may be relayed to a participant without additional context. However, additional discussion of the performance metrics yields insights into strengths that the participant may not be fully leveraging, or areas where the participant has been previously unaware of or unable to demonstrate/validate the participant's style leanings or knowledge domain expertise. As an example, “Hi, I'm Mike and I am a creative guy who is really great at navigating corporate politics!” might be credible, but an assessment experience score in the top 2% for creativity and navigating political landscapes provides credibility to a corporate recruiter.

A Challenge Bank may provide multiple environment scenarios for a variety of work settings. Challenges are selected and pulled from the Challenge Bank to form a particular assessment for the participant to be immersed in. In one embodiment, the challenge selection is driven by two mechanisms. The first mechanism is a tagging and labeling scheme which draws from multiple knowledge domains and results in assessments that simultaneously evaluate more than one knowledge domain for any given assessment. By contrast, traditional assessments evaluate one knowledge domain at a time (e.g., the verbal reasoning portion of the SAT). The second mechanism is a triggering mechanism that uses input from the participant's choices made dynamically while engaged in the assessment experience. The triggering mechanism pulls challenges in real time from the Challenge Bank to expose the participant to new challenges within established constraints of difficulty, topic, and relatedness to information shared with the participant earlier in their assessment process. For example, working backwards from the set of challenges which would make a complete assessment, each assessment experience may be set up with three pools. The first pool may be a starting challenge pool where only 75% of this pool will be used for any individual experience, and the challenges are randomly selected and inserted in random order. Thus, two participants might be taking the same assessment experience, but each participant's initial screen will not be the same. This makes it hard for people to give tips to others who are taking the same experience, and gives people who test and re-test a slightly different experience. The second pool may be a time based challenge pool, where challenges flow in to the participant at pre-determined times. This pool may also be overpopulated with randomized selection and order of challenges when the challenges are utilized. The third pool may be a prompt-based challenge pool. Here, challenges flow in to the participant if, and only if, the participant completes a certain sequence of responses.

Thus, real-world scenarios may be simulated in a series of office communications emanating from and being referred back to characters in a simulated business environment. The simulation may also be constrained by a set of pre-established choices, time limits, access to supplemental materials (e.g., email attachments) and business content (e.g., a mock CNN update, a simulated phone message, a text chat box including evaluative information appearing within the online interface) introduced through the online interface. A time clock starts when the participant begins the assessment experience and every response is tracked, as well as when a message is viewed, when an attachment is opened and when a response is sent.

Business theory and research has demonstrated that there are different best practices for different types of firms/companies (e.g., high growth startups versus dominant incumbent players, or international joint ventures that benefit more from certain managerial behaviors than do domestic family owned businesses). By signaling to the participant what case situation the participant is in, the system may indirectly signal to the participant which suite of best practices the participant should utilize. For example, the best responses for “Influencing the Board” of a closely held mature firm will differ from the best responses for “Influencing the Board” of a public multinational-company growing through acquisitions. Business experts (e.g., PhDs and experienced practitioners) may continue to build an additional dimension to the system experiences, umbrella topics and challenges that are based on case situations.

In one embodiment, the system may provide for royalty payments to providers/authors adding to the database of assessment questions and case situational elements. For example, an author or group of authors may be associated with each challenge. The system tracks the challenges used in each experience and keeps a running tally of the usage numbers by challenge. Each quarter, the system calculates overall usage and informs the authors of their royalties. Payments under a minimum ($250) are held over until a subsequent quarter when they exceed this minimum, at which time payment is made. Real time payments may also be made upon a participant's completion of any assessment experience, where the authors of the challenges utilized are paid electronically.

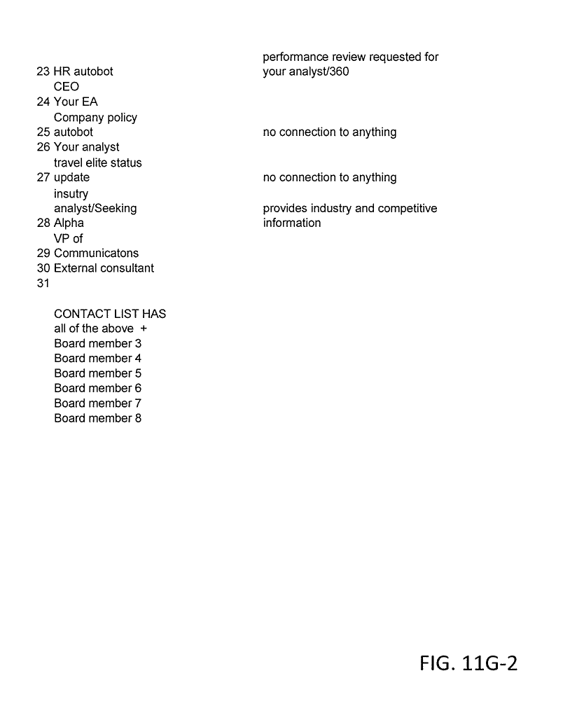

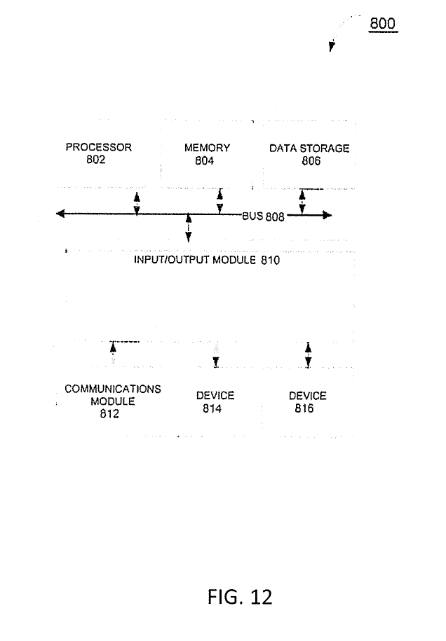

Referring now to FIG. 12, this figure conceptually illustrates an electronic system 800 with which one or more embodiments of the subject technology may be implemented.

Electronic system 800, for example, can be a server, a desktop computer, a laptop computer, a tablet computer, a phone, a personal digital assistant (PDA) or generally any electronic device that transmits signals over a network (e.g., time clocks, proximity badges, biometric identification schemes, and the like). Such an electronic system includes various types of computer readable media and interfaces for various other types of computer readable media. Electronic system 800 includes bus 808, processing unit(s) 812, system memory 804, read-only memory (ROM) 810, permanent storage device 802, input device interface 814, output device interface 806 and network interface 816, or subsets and variations thereof.

Bus 808 collectively represents all system, peripheral and chipset buses that communicatively connect the numerous internal devices of electronic system 800. In one or more embodiments, bus 808 communicatively connects processing unit(s) 812 with ROM 810, system memory 804 and permanent storage device 802. From these various memory units, processing unit(s) 812 retrieves instructions to execute and data to process in order to execute the processes of the subject disclosure. The processing unit(s) can be a single processor or a multi-core processor in different embodiments.

ROM 810 stores static data and instructions that are needed by processing unit(s) 812 and other modules of the electronic system. Permanent storage device 802, on the other hand, is a read-and-write memory device. This device is a non-volatile memory unit that stores instructions and data even when electronic system 800 is off. One or more embodiments of the subject disclosure use a mass-storage device (such as a magnetic or optical disk and its corresponding disk drive) as permanent storage device 802.

Other embodiments use a removable storage device (such as a floppy disk, flash drive, and its corresponding disk drive) as permanent storage device 802. Like permanent storage device 802, system memory 804 is a read-and-write memory device. However, unlike storage device 802, system memory 804 is a volatile read-and-write memory, such as random access memory. System memory 804 stores any of the instructions and data that processing unit(s) 812 needs at runtime. In one or more embodiments, the processes of the subject disclosure are stored in system memory 804, permanent storage device 802, and/or ROM 810. From these various memory units, processing unit(s) 812 retrieves instructions to execute and data to process in order to execute the processes of one or more embodiments.

Bus 808 also connects to input and output device interfaces 814 and 806. Input device interface 814 enables a user to communicate information and select commands to the electronic system. Input devices used with input device interface 814 include, for example, alphanumeric keyboards and pointing devices (also called “cursor control devices”). Output device interface 806 enables, for example, the display of images generated by electronic system 800. Output devices used with output device interface 806 include, for example, printers and display devices, such as a liquid crystal display (LCD), a light emitting diode (LED) display, an organic light emitting diode (OLED) display, a flexible display, a flat panel display, a solid state display, a projector or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech or tactile input.

Also, as shown in FIG. 12, bus 808 also couples electronic system 800 to a network (not shown) through network interface 816. In this manner, the computer can be a part of a network of computers (such as a local area network (“LAN”), a wide area network (“WAN”), or an Intranet, or a network of networks, such as the Internet. Any or all components of electronic system 800 can be used in conjunction with the subject disclosure.

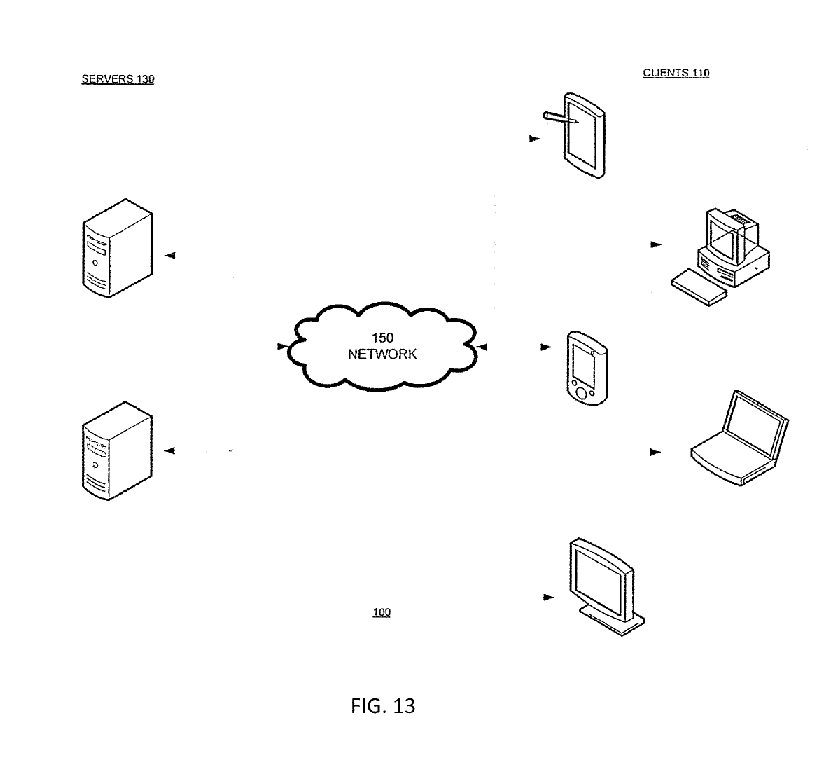

FIG. 13 shows an example network environment in which a skills assessment system may be implemented.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more embodiments, the computer readable media does not include carrier waves and electronic signals passing wirelessly or over wired connections or any other ephemeral signals. For example, the computer readable media may be entirely restricted to tangible, physical objects that store information in a form that is readable by a computer. In one or more embodiments, the computer readable media is non-transitory computer readable media, computer readable storage media or non-transitory computer readable storage media.

In one or more embodiments, a computer program product (also known as a program, software, software application, script or code) can be written in any form of programming language, including compiled or interpreted languages, declarative or procedural languages, and it can be deployed in any form, including as a stand-alone program or as a module, component, subroutine, object or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged. Additionally, all illustrated blocks may or may not be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise,” as “comprise” is interpreted when employed as a transitional word in a claim. Furthermore, to the extent that the term “include,” “have,” or the like is used in the description or the claims, such term is intended to be inclusive in a manner similar to the term “comprise,” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

Reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A system for providing skills assessment, the system comprising:
one or more processors; and
a computer-readable medium comprising instructions stored therein, which when executed by the processors, cause the processors to perform operations comprising:
determining one or more challenges for a participant;
providing the one or more challenges to at least one electronic device associated with the participant;
monitoring responses of the participant to the one or more challenges, wherein the responses are input via the at least one electronic device; and
determining a performance assessment for the participant based on the responses of the participant to the one or more challenges.

2. The system of claim 1, further comprising:
providing one or more distractions to the at least one electronic device;
monitoring responses of the participant to the one or more distractions, wherein the responses are input via the at least one electronic device; and
determining a performance assessment for the participant based on the responses of the participant to the one or more challenges and one or more distractions.

3. The system of claim 1, wherein the performance assessment includes the participant's strengths in one or more business knowledge domains.

4. The system of claim 3, wherein the one or more business knowledge domains comprise any of critical thinking, strategic communications, ethics, cybersecurity and entrepreneurship.

5. The system of claim 1, wherein the performance assessment includes the participant's ability to address business challenges consistently.

6. The system of claim 1, wherein the performance assessment includes the participant's use of established best practices.

7. The system of claim 1, wherein the performance assessment includes the participant's stylistic preferences and expressions of creativity and intuition.

8. The system of claim 1, wherein the performance assessment includes the participant's reliance on hard data.

9. The system of claim 1, wherein the performance assessment includes the participant's reliance on personal networks.

10. The system of claim 1, wherein the performance assessment includes the participant's pattern recognition.

10. The system of claim 1, wherein the performance assessment includes the participant's relative ranking versus other assessment participants.

11. The system of claim 1, further comprising a database of challenges, each challenge comprising:
a level of difficulty;
a length of time;
a defined number of possible solutions;
an amount of information accessible by the participant; and
an association with at least on knowledge domain.

12. The system of claim 11, wherein the database of challenges further comprises conversation threads.

13. The system of claim 1, further comprising at least one algorithm for selection of challenges that make up an assessment.

14. The system of claim 13, wherein the at least one algorithm comprises consideration of the most important skills and behaviors needed to succeed in a management role.

15. The system of claim 14, further comprising one or more of templates of dominant skills sets, competence maps and domain expertise, wherein the one or more templates identify and tag the skills and behaviors.

16. The system of claim 13, wherein the at least one algorithm comprises consideration of examples of high performing managers demonstrating successful skills.

17. The system of claim 13, wherein the at least one algorithm comprises consideration of the most common mistakes that managers make.

18. The system of claim 1, further comprising a scoring system that normalizes varied experiences and provides for comparable scores to be generated across individuals and populations.

19. A computer implemented method for providing skills assessment, the method comprising:
determining, by one or more processors, one or more challenges for a participant;
providing the one or more challenges to at least one electronic device associated with the participant;
monitoring, by the one or more processors, responses of the participant to the one or more challenges, wherein the responses are input via the at least one electronic device;
providing, by the one or more processors, one or more distractions to the at least one electronic device;
monitoring, by the one or more processors, responses of the participant to the one or more distractions, wherein the responses are input via the at least one electronic device; and
determining, by the one or more processors, a performance assessment for the participant based on the responses of the participant to the one or more challenges and the one or more distractions.

20. The computer implemented method of claim 19, further comprising:
selecting, by at least one processor based algorithm, one or more challenges that make up an assessment, wherein the algorithm comprises at least one of:
consideration of the most important skills and behaviors needed to succeed in a management role;
consideration of examples of high performing managers demonstrating successful skills; and
consideration of the most common mistakes that managers make.
